(19) United States
(12) Patent Application Publication
(10) Pub. No.: US 2026/0170729 A1
(43) Pub. Date: Jun. 18, 2026

(54) STORAGE MEDIUM, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: TAKAYUKI KAWASHIMA, Kanagawa (JP)

(21) Appl. No.: 19/413,450

(22) Filed: Dec. 9, 2025

(30) Foreign Application Priority Data
Dec. 18, 2024 (JP) 2024-221919

(51) Int. Cl. G06T 11/60; G06F 40/58

(52) U.S. Cl. CPC G06T 11/60; G06F 40/58; G06T 2200/24

(57) ABSTRACT

Provided is a non-transitory computer-readable storage medium storing a program causing an information processing apparatus communicably connected with a terminal device to execute a method, the method having causing the information processing apparatus to function as: an acceptance unit configured to accept a changing instruction to change a layout of design data including text from the terminal device; a control unit configured to perform control which specifies an element to be emphasized from among elements included in the text based on the design data in a case where the changing instruction is accepted; and a changing unit configured to change a character set of the element specified by the control unit.

### BACKGROUND

### Field of the Technology

The present disclosure relates to a storage medium, an information processing apparatus, and a method of controlling an information processing apparatus.

### Description of the Related Art

There are systems that assist creation of data of the designs of posters or flyers (hereinafter referred to as “design data”). Among such systems, there is one that has a function of collectively changing the character set of the elements forming the text in the region provided to each text-representing object included in design data (hereinafter referred to as “text region”) to one character set and displaying the resulting text. A “character set” indicates the size of elements such as characters forming text included in a text-representing object, the color of the elements, the font type of the elements, bolding decoration for the elements, italicizing decoration for the elements, underling decoration for the elements, or the like.

Patent Document (Japanese Patent Laid-Open No. 2019-74858) discloses a technique in which, by accepting a user's selection indicating whether the importance level of a character string input into an input region is high or not, a character string having a high importance level is displayed in a larger size than a character string having a low importance level.

There has been a demand to improve usability in creation of text-related objects for creation of design data.

### SUMMARY

An aspect of the present disclosure provides a non-transitory computer-readable storage medium storing a program causing an information processing apparatus communicably connected with a terminal device to execute a method, the method having causing the information processing apparatus to function as: an acceptance unit configured to accept a changing instruction to change a layout of design data including text from the terminal device; a control unit configured to perform control which specifies an element to be emphasized from among elements included in the text based on the design data in a case where the changing instruction is accepted; and a changing unit configured to change a character set of the element specified by the control unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an entire system according to one or more aspects of the present disclosure;

FIG. 2A is a diagram illustrating an example of a hardware configuration of a host personal computer (PC);

FIG. 2B is a diagram illustrating an example of a hardware configuration of a service server;

FIG. 3 is a diagram illustrating an example of a software configuration of the system;

FIG. 4A is a diagram illustrating an example of a data table for design data;

FIG. 4B is a diagram illustrating an example of a text object data table;

FIG. 5A is a diagram illustrating an example of a process which can be executed by a multimodal large language model;

FIG. 5B is a diagram illustrating an example of a process to be executed by the multimodal large language model;

FIG. 6 is a diagram illustrating an example of an editing screen of a poster creation application;

FIG. 7 is a sequence chart illustrating an example of processing to be executed by the host PC and the service server;

FIG. 8A is a diagram illustrating an example of the editing screen displayed in a case where a character set change button on the editing screen is pressed;

FIG. 8B is a diagram illustrating an example of the editing screen after the display of design data is updated;

FIG. 9 is a flowchart illustrating an example of processing to be executed by the host PC;

FIG. 10 is a flowchart illustrating an example of processing to be executed by the service server;

FIG. 11A is a diagram illustrating an example of the editing screen of the poster creation application with a character set change setting region displayed;

FIG. 11B is a diagram illustrating an example of the editing screen after a character set changing process is executed;

FIG. 12 is a flowchart illustrating an example of processing to be executed by the service server;

FIG. 13A is a diagram illustrating the editing screen of the poster creation application with design data displayed as the result of a character set changing process;

FIG. 13B is a diagram illustrating the editing screen of the poster creation application with a re-execute button displayed in a character set change setting region;

FIG. 13C is a diagram illustrating the editing screen of the poster creation application with an object to be subjected to re-estimation of to-be-emphasized elements selected;

FIG. 13D is a diagram illustrating the editing screen of the poster creation application after executing the re-estimation of to-be-emphasized elements;

FIG. 14 is a flowchart illustrating an example of processing to be executed by the service server;

FIG. 15A is a diagram illustrating an example of a prompt for causing the multimodal large language model to re-estimate to-be-emphasized elements;

FIG. 15B is a diagram illustrating an example of the result of the re-estimation of to-be-emphasized elements;

FIG. 16A is a diagram illustrating an example of the editing screen of the poster creation application with a translation setting region displayed;

FIG. 16B is a diagram illustrating an example of the editing screen of the poster creation application after executing a character set changing process involving text translation;

FIG. 17 is a flowchart illustrating an example of an acceptance process of accepting a character set changing instruction and a process of updating the display of design data to be executed by the poster creation application;

FIG. 18 is a flowchart illustrating an example of processing to be executed by the service server;

FIG. 19 is a sequence chart illustrating an example of processing to be executed by the host PC and the service server;

FIG. 20 is a flowchart illustrating an example of an acceptance process of accepting a character set changing instruction and a process of updating the display of design data to be executed by the poster creation application;

FIG. 21A is a diagram illustrating an example of the editing screen of the poster creation application with an out-of-region text notification displayed;

FIG. 21B is a diagram illustrating an example of the editing screen of the poster creation application with a character set change setting region displayed; and

FIG. 22 is a flowchart illustrating an example of processing to be executed by the service server.

### DESCRIPTION OF THE EMBODIMENTS

Preferred embodiments of the present disclosure will be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical components will be described with the same reference sign given thereto.

Among systems that assist creation of design data such as posters or flyers, there is one that has a function of collectively changing the character set of the elements forming the text in the region of each text-representing object included in design data (“text region”) to one character set and displaying the resulting text. Here, the elements forming the text (included in the text) (hereinafter such elements will be expressed as “the elements of the text”) refer to the elements of text formed of characters, numbers, symbols, or a combination of these.

Note that, in the case where the above system collectively changes the character set of the elements of the text in each text region to one character set and displays the resulting text, the elements to be displayed in an emphasized manner among the elements of the text (hereinafter referred to as “to-be-emphasized elements”) may have lower visual perceptibility.

Thus, from the viewpoint of ensuring the visual perceptibility of to-be-emphasized elements, one may consider a technique which involves accepting the user's selection of elements to be emphasized from among the elements of text and making the to-be-emphasized elements larger than the other elements in the text. With this method, however, it is necessary to accept, for each element, the user's selection of whether it is a to-be-emphasized element, and it may be impossible to automatically specify the to-be-emphasized elements and change the character set of these to-be-emphasized elements.

In the following, a description will be given of a technique for improving usability in creation of text-related objects for creation of design data. Specifically, a description will be given of a technique capable of automatically specifying to-be-emphasized elements from among the elements of text and changing the character set of the specified to-be-emphasized elements.

### First Embodiment

### Configuration of Entire System

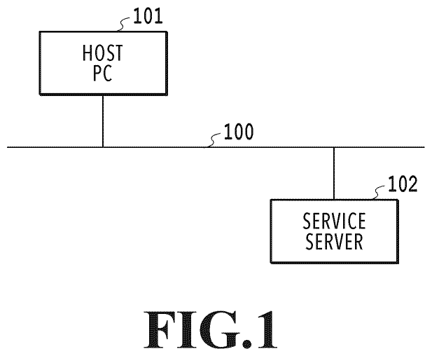

FIG. 1 is a diagram illustrating an example of a configuration of a design changing system in a first embodiment. The design changing system includes a host PC 101 and a service server 102. The host PC 101 and the service server 102 are connected to be capable of communicating with each other through a network 100. Examples of this network 100 include the Internet, a wired local area network (LAN), a wireless LAN, and the like.

The following description will be given based on an example in which the host PC 101 is a terminal device that executes an application capable of generating and editing design data of posters, flyers, or the like (hereinafter referred to as “poster creation application”).

Note that the type of the host PC 101 is not limited as long as it is an information processing apparatus capable of executing the poster creation application. For example, the host PC 101 may be a desktop PC, a laptop PC, a tablet terminal, a smartphone, or the like.

The host PC 101 is capable of transmitting a request for an editing process, data processing, and rendering on part of design data to the service server 102 through the poster creation application.

The following description will be given based on an example in which the service server 102 is a server that executes the editing process, the data processing, and the rendering on design data. Note that the type of the service server 102 is not limited as long as it is an information processing apparatus capable of executing the above processes on design data. For example, the service server 102 may be a desktop PC, a laptop PC, or the like.

The design changing system in the present embodiment includes the host PC 101 and the service server 102, but the configuration is not limited to this. For example, the host PC 101 may also serve the function of the service server 102. Alternatively, the host PC 101 and the service server 102 may each be two or more host PCs or service servers.

### Hardware Configuration of Host PC

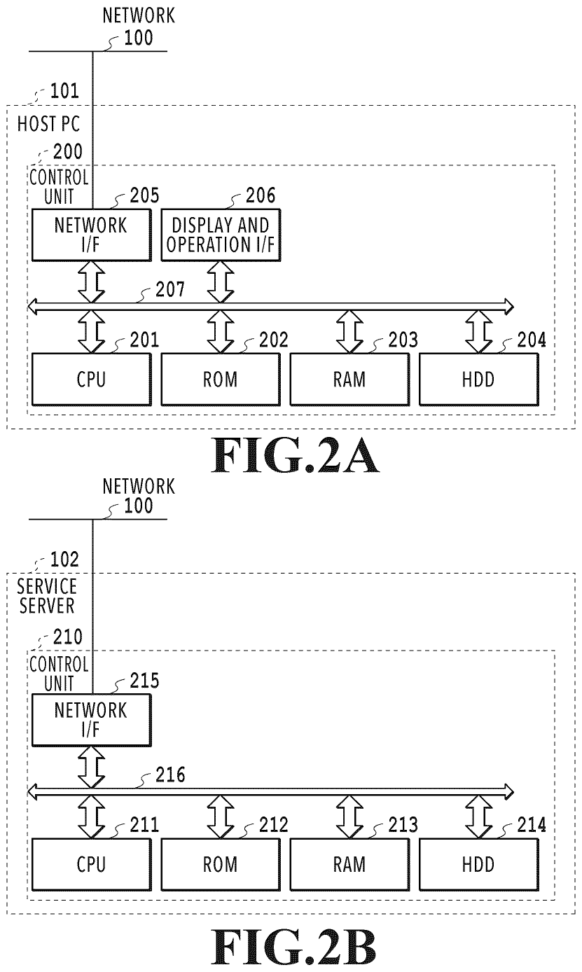

FIG. 2A is a diagram illustrating an example of a hardware configuration of the host PC 101. A control unit 200 includes a central processing unit (CPU) 201, a read-only memory (ROM) 202, a random-access memory (RAM) 203, a hard disk drive (HDD) 204, a network interface (I/F) 205, and a display and operation I/F 206. These are connected to one another through a system bus 207. The control unit 200 controls the operation of the entire host PC 101.

The CPU 201 reads out various programs, such as a control program, a system program, and an application program, stored in storage devices, such as the ROM 202 and the HDD 204, into the RAM 203. Then, the CPU 201 executes the various programs thus read out. In this way, the CPU 201 can implement various functions of the host PC 101.

The storage devices store and hold various programs, image data, and the like. Examples of the storage devices include the ROM 202, which is a non-volatile memory, the RAM 203, which is a volatile memory, the HDD 204, which is a large-capacity storage, and the like. The ROM 202 is a non-volatile memory holding various programs. The CPU 201 is capable of reading the various programs out of the ROM 202. The RAM 203 is a main memory for the CPU 201, and is a volatile memory to be used as a temporary storage area such as a work area.

The HDD 204 is a non-volatile memory to be used as a large-capacity storage area to save data such as images and the like and programs such as applications. The HDD 204 may be a solid-state drive (SSD), a flash memory, or a cloud storage.

The network I/F 205 connects the control unit 200 of the host PC 101 to the network 100. The control unit 200 is capable of transmitting various pieces of data and various pieces of information to external apparatuses on the network 100 and receiving various pieces of data and various pieces of information from external apparatuses on the network 100 through the network I/F 205.

The display and operation I/F 206 connects the control unit 200 of the host PC 101 to an output device such as a display (not illustrated) and input devices such as a keyboard and a mouse (not illustrated). The present embodiment will be described based on an example in which the input devices and the output device are separate devices, but the configuration of the input devices and the output device is not limited to this. For example, the output device and the input devices may be configured integrally with each other, like a display with a touch panel function. In this case, the control unit 200 is capable of detecting the operator's operations on the display through the display and operation I/F 206.

### Hardware Configuration of Service Server

FIG. 2B is a diagram illustrating an example of a hardware configuration of the service server 102. The control unit 210 includes a CPU 211, a ROM 212, a RAM 213, an HDD 214, and a network I/F 215. These are connected to one another through a system bus 216. The functions of the components included in the control unit 210 are similar to those of the CPU 201, the ROM 202, the RAM 203, the HDD 204, and the network I/F 205 described above, respectively, and detailed description thereof is omitted.

The control unit 210 including the CPU 211 controls the operation of the entire service server 102. The CPU 211 reads out various programs, such as a control program, a system program, and an application program, stored in storage devices, such as the ROM 212 and the HDD 214, into the RAM 213. Then, the CPU 211 executes the various programs thus read out. In this way, the CPU 211 can implement various functions of the service server 102.

The ROM 212 is a non-volatile memory holding various programs. The RAM 213 is a main memory for the CPU 211, and is used as a temporary storage area such as a work area. The HDD 214 stores document data, various programs, and the like. The HDD 214 may be an SSD, a flash memory, or a cloud storage.

The network I/F 215 connects the control unit 210 of the service server 102 to the network 100. The service server 102 is capable of receiving process requests from other apparatuses, such as the host PC 101, through the network I/F 215. Also, the service server 102 is capable of transmitting various pieces of data, various pieces of information, and the like to the transmission sources of the received process requests through the network I/F 215 in response to the process requests. A “process request” is a request instructing the service server 102 to execute a predetermined process.

### Software Configuration of System

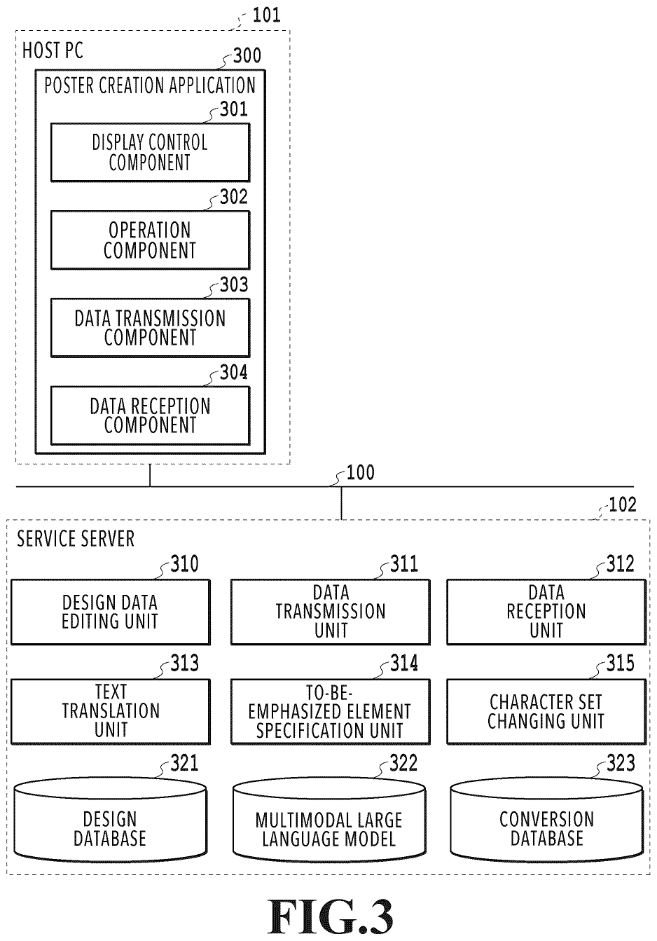

FIG. 3 is a diagram illustrating an example of a software configuration of the system. Software configurations of the host PC 101 and the service server 102 will now be described with reference to FIG. 3.

The host PC 101 has a poster creation application 300. The following description will be given based on an example in which the poster creation application 300 in the present embodiment is an application being a program that is capable of executing a process of editing design data of a poster, a flyer, or the like.

The program of the poster creation application 300 is stored in a storage device such as the ROM 202 or the HDD 204. The CPU 201 can read the program of the poster creation application 300 out of the RAM 203 and execute the program of the poster creation application 300 thus read out.

Also, the poster creation application 300 includes a display control component 301, an operation component 302, a data transmission component 303, and a data reception component 304. The display control component 301 displays an editing screen of the poster creation application 300 on the display through the display and operation I/F 206. The operation component 302 accepts user inputs from the input devices through the display and operation I/F 206. The data transmission component 303 transmits a process request for design data based on an instruction from the operation component 302 to the service server 102 through the network I/F 205. The data reception component 304 receives the result of the processing of the design data from the service server 102 through the network I/F 205.

The service server 102 include a design data editing unit 310, a data transmission unit 311, a data reception unit 312, a text translation unit 313, a to-be-emphasized element specification unit 314, and a character set changing unit 315. Also, the service server 102 includes a design database 321, a multimodal large language model 322, and a conversion database 323.

The design data editing unit 310 edits the design data of a poster, a flyer, or the like based on an instruction from the poster creation application 300 of the host PC 101. For example, the design data editing unit 310 adds and deletes objects, such as text, images, or figures, to and from the design data or changes the coordinates, sizes, and colors of objects. Design data is saved in the design database 321 individually for the poster creation application 300 of each host PC 101 (or for each account in a case where multiple user accounts exist).

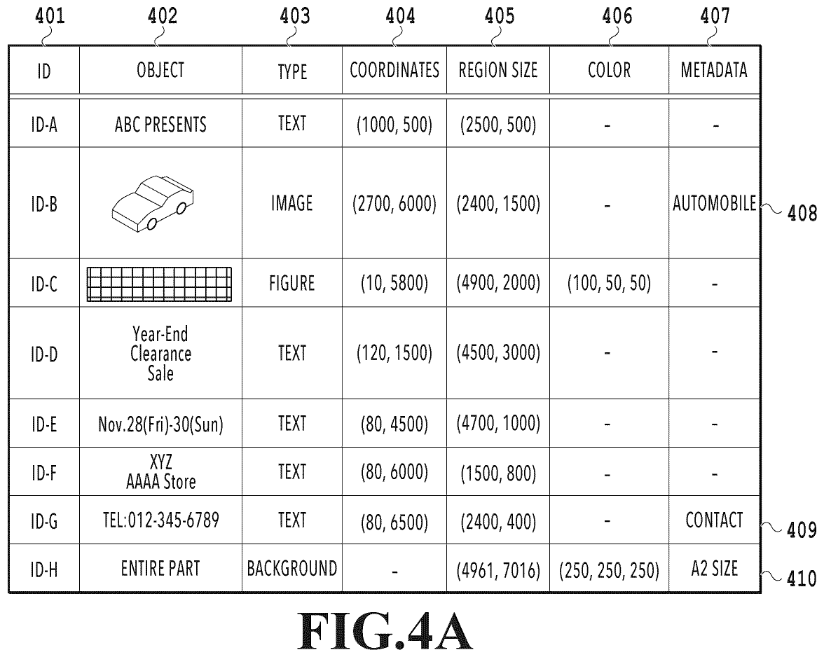

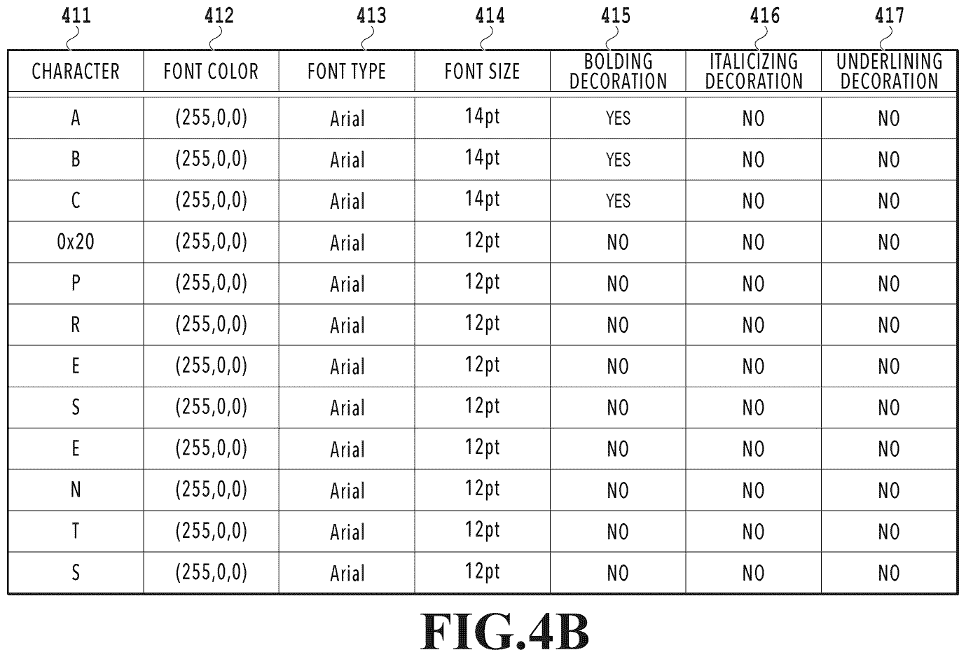

Here, FIG. 4A is a diagram illustrating an example of a data table for design data stored in the design database 321 and managed by the service server 102. The data table illustrated in FIG. 4A includes parameters indicating an ID 401 for uniquely identifying an object included in design data, an object 402, a type 403, coordinates 404, a region size 405, a color 406, and metadata 407.

As the object 402, the content of an object such as text, an image, or a figure included in the design data is set. For example, an image representing a vehicle is set as the object 402 associated with the ID 401 “ID-B.” Also, text included in a text-representing object is set as the object 402 associated with the ID 401 “ID-D.”

As the type 403, information indicating the type of the object is set. As the coordinates 404, values indicating the position of the object in the layout of the design data is set. As the region size 405, a value indicating the size of the text region of the object is set. In the present embodiment, in a case where the type 403 is “text,” for example, the coordinates 404 and the region size 405 indicate the coordinates where a text region prepared for the text is located, and the size of the text region, respectively.

As the color 406, a value indicating the color of the object is set using an RGB value. Note that, for text-representing objects and image-representing objects, values indicating the colors of these objects do not need to be set as their colors 406. Also, the color 406 may be set using an HSV value instead of an RGB value.

As the metadata 407, metadata of the object is set. In the present embodiment, in a case where the type 403 is “image” or “text,” for example, a description of the image or the text or an attribute of the object can be set as the metadata. For example, a description of an image as indicated by an item 408 or an attribute of text as indicated by an item 409 can be set as the metadata 407. Also, in a case where the type 403 is “background,” the background's document size can be set as the metadata. For example, “A2 Size” as indicated by an item 410 can be set as the metadata. Also, no metadata may be set depending on the object.

In the present embodiment, the data table illustrated in FIG. 4A is stored in the design database 321 for each piece of design data. Note that the data table illustrated in FIG. 4A may be stored in the design database 321 for each object type, and may include parameters other than those described above.

In the present embodiment, in a case where the type 403 is “text,” parameters such as the colors of the elements of text included in the text-representing object (hereinafter referred to as “text object”) are held in the design database 321 in the form of a text object data table. Note that the text object data table is held in the design database 321 in association with the ID 401.

FIG. 4B is a diagram illustrating an example of a text object data table for “ID-A” in FIG. 4A. In the text object data table, parameter values are sequentially set for the elements of the text included in the text object. For example, the following description will be given based on an example in which the elements of the text included in a text object each exemplarily mean one unit character forming the text included in the text object, as illustrated in FIG. 4B. Also, it is needless to say that the elements of the text included in a text object each mean one number or one symbol in a case where the text includes numbers or symbols. Note that the elements of the text included in a text object are not limited to these.

For example, the elements of the text included in a text object may each mean one word or one sentence. Further, these elements may be managed on a word-by-word basis or a sentence-by-sentence basis in the service server 102. Furthermore, these words may be categorized and managed by the part of speech.

The text object data table illustrated in FIG. 4B includes parameters indicating a character 411, a font color 412, a font type 413, a font size 414, bolding decoration 415, italicizing decoration 416, and underling decoration 417.

As the character 411, a value representing a character forming the text included in the text object associated with the ID 401 “ID-A” is set. As the font color 412, a value indicating the color of the character set as the character 411 is set using an RGB value. Note that the value indicating the color of the character set as the character 411 may be set as the font color 412 using an HSV value instead of an RGB value. As the font type 413, a value indicating the font type of the character set as the character 411 is set. As the font size 414, a value indicating the size of the character set as the character 411 is set.

As the bolding decoration 415, a value indicating whether to bold the character set as the character 411 is set. As the italicizing decoration 416, a value indicating whether to italicize the character set as the character 411 is set. As the underling decoration 417, a value indicating whether to underline the character set as the character 411 is set. The present embodiment will be described based on an example in which the parameters of the font color 412 to the underling decoration 417 are the character set of the character that is set as the character 411. Note that a “character set” represents the size of an element such as a character forming text included in a text-representing object, the color of the element, the font type of the element, bolding decoration for the element, italicizing decoration for the element, and underling decoration for the element, or the like.

Referring to the text object data table illustrated in FIG. 4B, it can be seen that “FONT SIZE” is set to “14 pt” and “BOLDING DECORATION” is “Yes” for the three characters “ABC” in the character string “ABC PRESENTS.” In the present embodiment, the text object data table illustrated in FIG. 4B is stored in the design database 321 for each text object. Note that the text object data table illustrated in FIG. 4B include parameters other than those described above. That is, parameters other than the font color 412 to the underling decoration 417 may be used as a character set of the character that is set as the character 411.

Referring back to FIG. 3, the data transmission unit 311 transmits the result of the processing of the design data to the poster creation application 300 of the host PC 101 through the network I/F 215. The data reception unit 312 receives the process request for the design data from the poster creation application 300 of the host PC 101 through the network I/F 215.

The text translation unit 313 performs machine translation on the text included in the text objects included in the design data from a first language to a second language. For example, in a case where the text included in a text object is written in English and the process request for the design data includes a translation instruction to perform English-to-Japanese translation, the text translation unit 313 translates the text from English to Japanese. Note that the language into which the text translation unit 313 can translate text is not limited to Japanese and may be English or other languages.

The conversion database 323 holds text translation setting information. The text translation setting information refers to setting information including translatable languages, locales indicating countries or regions, and information in which each locale and a translatable language or languages are associated with each other. The to-be-emphasized element specification unit 314 specifies elements to be emphasized among the elements of the text included in text objects by utilizing the multimodal large language model 322. The character set changing unit 315 is capable of changing the parameter values in the text object data table associated with the elements specified by the to-be-emphasized element specification unit 314, that is, changing the character set of these elements.

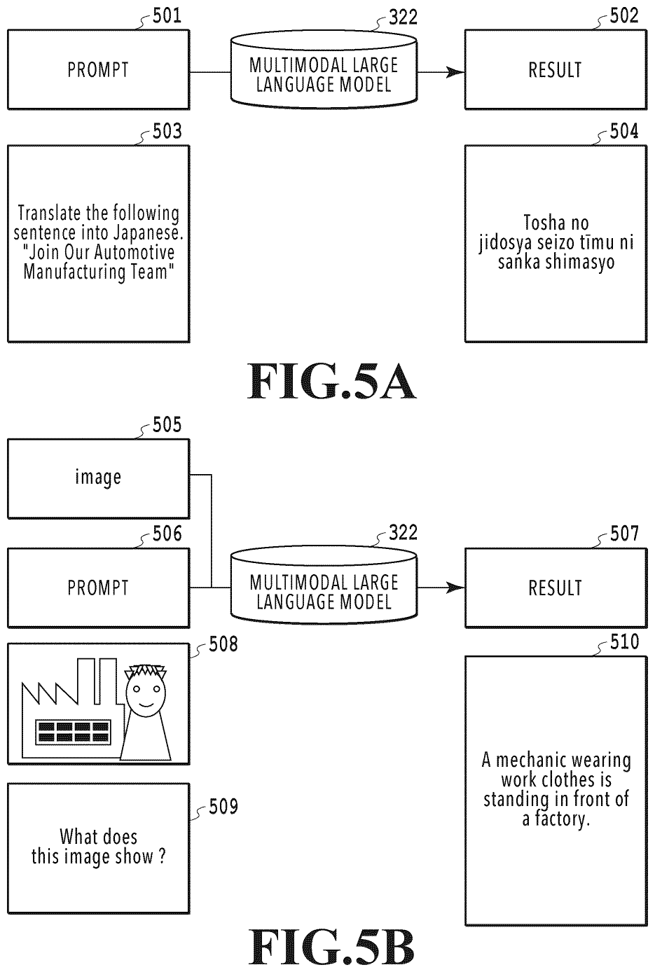

FIGS. 5A and 5B are diagrams illustrating an example of processes to be executed by the multimodal large language model 322. Before describing the multimodal large language model 322, a large language model will be described.

A large language model is a trained model that includes multiple neural network layers and has been trained with a large amount of text. Each neural network layer's parameters are adjusted by causing it to learn a task of predicting an element (a character, a word, or a sentence) that is likely to follow a given element (a character, a word, or a sentence). In this way, the large language model can generate text having a high probability of matching input text. For example, in a case where a prompt “What day comes after Friday?” is input, the large language model can generate text “It is Saturday. ,” which has a high probability of matching the prompt.

Specifically, the large language model divides the input text into tokens, which are basis processing units, and then converts each token into an embedding representation that numerically expresses the meaning of a word or a sentence. One example of the conversion of each token into an embedding representation is converting the token into a high-dimensional numerical vector. By converting each token into an embedding representation, the large language model can numerically express the meaning of the input text. Based on the converted embedding representation, the large language model can generate text having a high probability of matching this embedding representation.

The multimodal large language model 322 is a large language model that has been trained to handle not only the character strings of text and the like but also different types of information such as images, speech, and videos. The multimodal large language model, into which images can be input, is capable of deriving feature amounts of an input image from the image by using an image encoder. The multimodal large language model then maps the derived feature amounts of the image to embedding representations (e.g., numerical vectors). In this way, the multimodal large language model can generate text having a high probability of matching input text and image. Also, the multimodal large language model is capable of outputting input text and image in the form of embedding representations.

Further, the multimodal large language model 322 is capable of handling various tasks that were not included in the training data in response to input text and image. For example, the multimodal large language model 322 is capable of translating text as illustrated in FIG. 5A and describing an image as illustrated in FIG. 5B.

FIGS. 5A and 5B are diagrams illustrating an example of processes that can be executed by the multimodal large language model 322. As illustrated in FIG. 5A, in a case where a prompt 501 indicating the content of an instruction for the multimodal large language model 322 is input, the model outputs text having a high probability of matching the prompt 501 as a result 502. In the specific example of FIG. 5A, the multimodal large language model 322 outputs a result 504 in a case where a prompt 503 is input.

Also, as illustrated in FIG. 5B, in a case where an image 505 and a prompt 506 are input, the multimodal large language model 322 can output text having a high probability of matching the image 505 and the prompt 506 as a result 507. In the specific example of FIG. 5B, the multimodal large language model 322 outputs a result 510 in a case where an image 508 and a prompt 509 are input. Specific examples of the multimodal large language model 322 include ChatGPT (https://chat.openai.com), Gemini (https://gemini.google.com), and the like. Note that any multimodal large language models are usable in the present embodiment.

Also, the multimodal large language model 322 is not limited to the above examples, and is capable of outputting one or more results based on a prompt with multiple instructions and multiple images that are input thereinto.

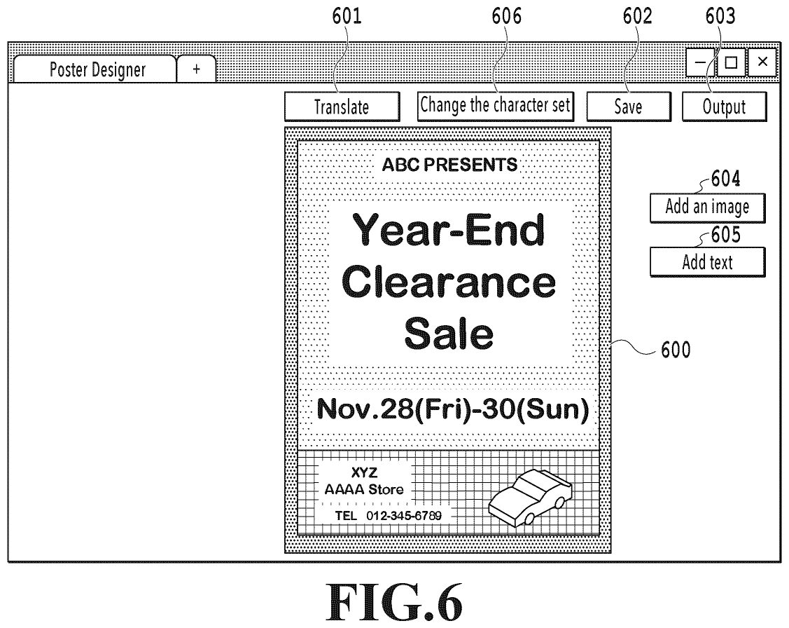

FIG. 6 is a diagram illustrating an example of the editing screen of the poster creation application 300. In response to an operation by the operator (hereinafter referred to as “user”) through the editing screen, the poster creation application 300 executes an editing process on part of design data and the like.

The editing screen illustrated in FIG. 6 is displayed on the display of the host PC 101 by the display control unit 301 through the poster creation application 300. On the editing screen illustrated in FIG. 6, a design editing region 600 is displayed. Also, the editing screen illustrated in FIG. 6 is provided with a translate button 601, a save button 602, an output button 603, an image addition button 604, a text addition button 605, and a character set change button 606.

In the design editing region 600, currently edited design data is displayed. Based on the user's editing operation and various inputs accepted by the operation component 302, the design data editing unit 310 changes the positions of objects included in the design data displayed in the design editing region 600 and the sizes and the like of the regions provided to the objects.

Also, in a case of adding an image-representing object or a text object to the currently edited design data displayed in the design editing region 600, the user presses the image addition button 604 or the text addition button 605.

In a case where the image addition button 604 is pressed, the poster creation application 300, for example, calls a file dialogue (not illustrated), designates the path to the file, and performs an import process. In a case where the text addition button 605 is pressed, the poster creation application 300 can, for example, newly generate a text object and display the generated text object in the design editing region 600.

Note that, in addition to the image addition button 604 and the text addition button 605, the editing screen illustrated in FIG. 6 may be provided with buttons for adding different types of objects to the currently edited design data.

Also, the import source for the import process to be performed in response to a press on the image addition button 604 is not limited to a file in the host PC 101 and may be a social networking service (SNS) to which folders or images on an external cloud can be uploaded. Also, the poster creation application 300 may accept addition of contents to the design editing region 600 through the editing screen by drag and drop.

In a case of translating the text included in the text objects included in the currently edited design data, the user presses the translate button 601. In a case of saving the currently edited design data, the user presses the save button 602. The design data at the time of pressing the save button 602 is saved to the design database 321. The poster creation application 300 can also output the currently edited design data in a Portable Document Format (PDF) format, a Joint Photographic Experts Group (JPEG) format, or the like in response to the press on the output button 603 by the user. In a case of changing the character set of the elements of the text included in the text objects included in the currently edited design data, the user presses the character set change button 606.

In FIG. 3, an example is described with a configuration in which the service server 102 has the design data editing unit 310, the text translation unit 313, the to-be-emphasized element specification unit 314, and the character set changing unit 315. The configuration of the service server 102 in the present embodiment is not limited to such a configuration. The poster creation application 300 of the host PC 101 may include the functions of the design data editing unit 310, the text translation unit 313, the to-be-emphasized element specification unit 314, and the character set changing unit 315. In other words, the poster creation application 300 of the host PC 101 may be configured to execute the later-described character set changing process to be executed by the service server 102.

### Processing Sequence

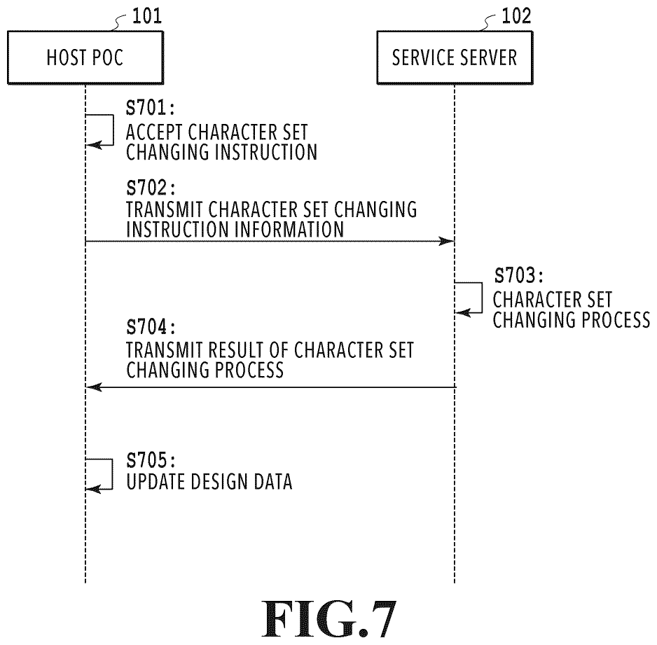

FIG. 7 is a sequence chart illustrating an example of processing to be executed by the host PC 101 and the service server 102. The flow of the processing to be performed between the host PC 101 and the service server 102 will now be described with reference to FIG. 7. Specifically, the description will be given of a procedure for updating the display of design data on the poster creation application 300 based on the result of a character set changing process executed by the service server 102 in response to a character set changing instruction being an instruction to change a character set.

Design data generated in accordance with an editing operation performed by the user through the poster creation application 300 is data stored in the design database 321 of the service server 102 and managed by the service server 102. Design data in the present embodiment is stored in the design database 321 of the service server 102, but where to store design data is not limited to this. Design data may be stored, for example, in an external storage device managed by the service server 102 or a cloud storage. Note that the information of the character set changing instruction mentioned above is managed by the host PC 101.

In S701, the operation component 302 of the poster creation application 300 accepts a character set changing instruction from the user through the display and operation I/F 206. The character set changing instruction includes information indicating whether to unify the font size of the elements of the text included in a text object or objects (hereinafter referred to as “font size unifying instruction information”). The character set changing instruction includes information indicating whether to vary the font size between elements of the text included in a text object or objects (hereinafter referred to as “font size varying instruction information”). While the present embodiment will be described based on an example in which the character set to be changed is the font size, the character set to be changed may be the font color, the font type, the bolding decoration, the italicizing decoration, or the underling decoration.

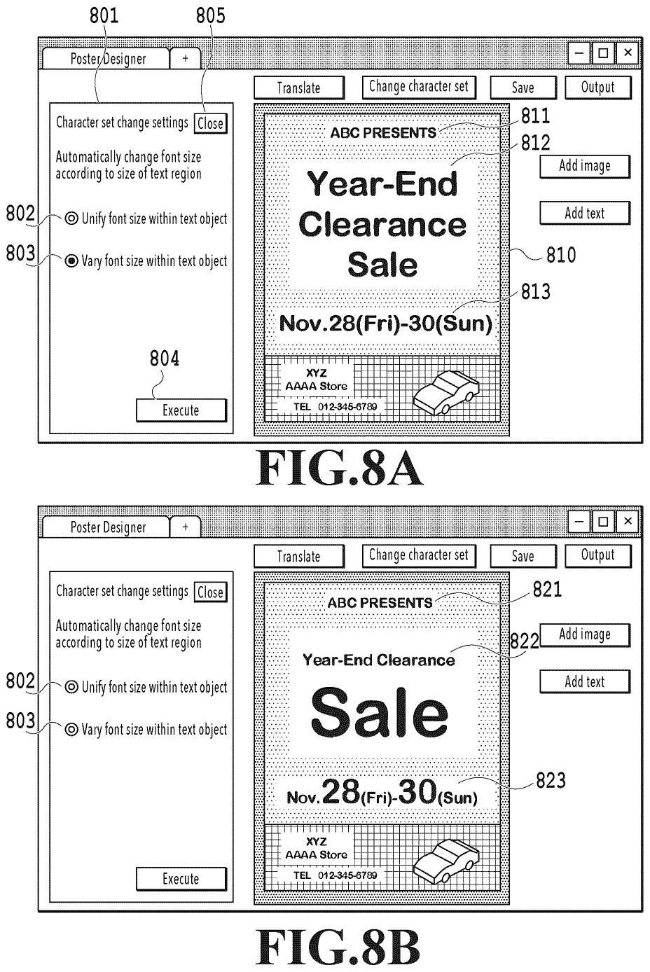

FIGS. 8A and 8B are diagrams illustrating an example of the editing screen of the poster creation application 300 before and after the execution of a process of changing the character set of the elements of the text included in text objects included in currently edited design data. An example of changing the character set of the elements of the text included in the text objects included in the currently edited design data will now be described with reference to FIGS. 8A and 8B.

FIG. 8A is a diagram illustrating an example of the editing screen displayed in a case where the character set change button 606 on the editing screen illustrated in FIG. 6 is pressed. As illustrated in FIG. 8A, in response to a press on the character set change button 606, a character set change setting region 801 is displayed on the editing screen. The character set change setting region 801 is provided with a setting item 802 capable of accepting an instruction to unify the font size of the elements of the text included in a text object within that text object (hereinafter referred to as “font size unifying instruction”). The character set change setting region 801 is provided with a setting item 803 capable of accepting an instruction to vary the font size between elements of the text included in a text object within that text object (hereinafter referred to as “font size varying instruction”).

Further, the character set change setting region 801 is provided with an execute button 804 that accepts a character set changing instruction along with the setting values of the setting items provided in the character set change setting region 801. Also, the character set change setting region 801 is provided with a close button 805 that accepts an instruction to close the character set change setting region 801. FIG. 8A illustrates a state where a font size varying instruction is set by the setting item 803.

In S702, the execute button 804 is pressed, in response to which the data transmission component 303 of the poster creation application 300 transmits information including the character set changing instruction (hereinafter referred to as “character set changing instruction information”) to the service server 102. The character set changing instruction information includes font size unifying instruction information and font size varying instruction information. Also, the character set changing instruction information includes an identification ID for identifying the currently edited design data.

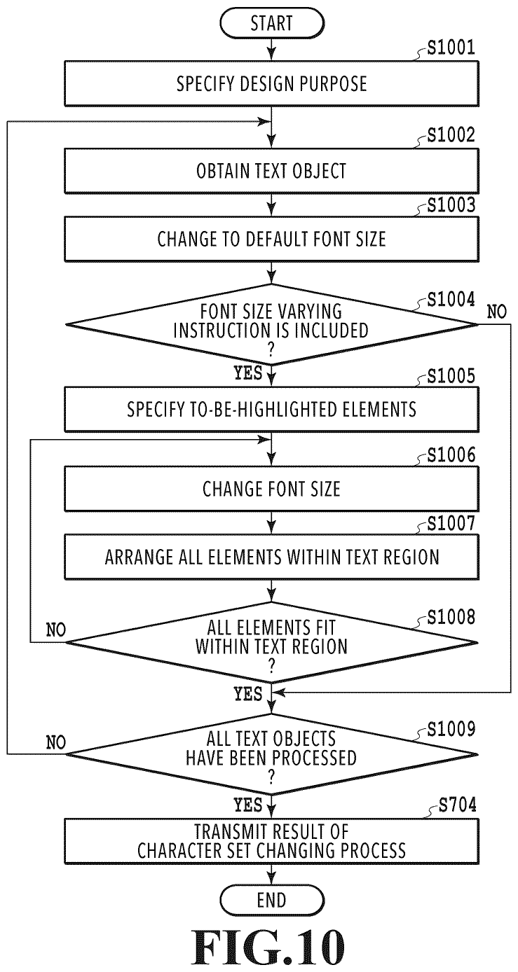

In S703, based on the character set changing instruction information received in S702, the service server 102 executes a process of changing the character set of the elements of the text included in a text object or objects included in the design data (hereinafter referred to as “character set changing process”). Details of the character set changing process executed by the service server 102 will be described with reference to FIG. 10.

In S704, the data transmission unit 311 of the service server 102 transmits the result of the character set changing process executed in S703 to the poster creation application 300 of the host PC 101.

In S705, the display control component 301 of the poster creation application 300 updates the currently edited design data displayed on the editing screen based on the result of the character set changing process received in S704. For example, the display control component 301 updates the currently edited design data as illustrated in FIG. 8B. Specifically, as illustrated in FIG. 8B, the font size of the word “Sale” among the elements of the text included in a text object 812 is larger than the font size of the other words “Year-End” and “Clearance.”

As illustrated in the above processing sequence, the poster creation application 300 of the host PC 101 can transmit information including a received character set changing instruction to the service server 102 and update the display of the design data based on a result given for the instruction.

### Flow of Processing by Host PC 101

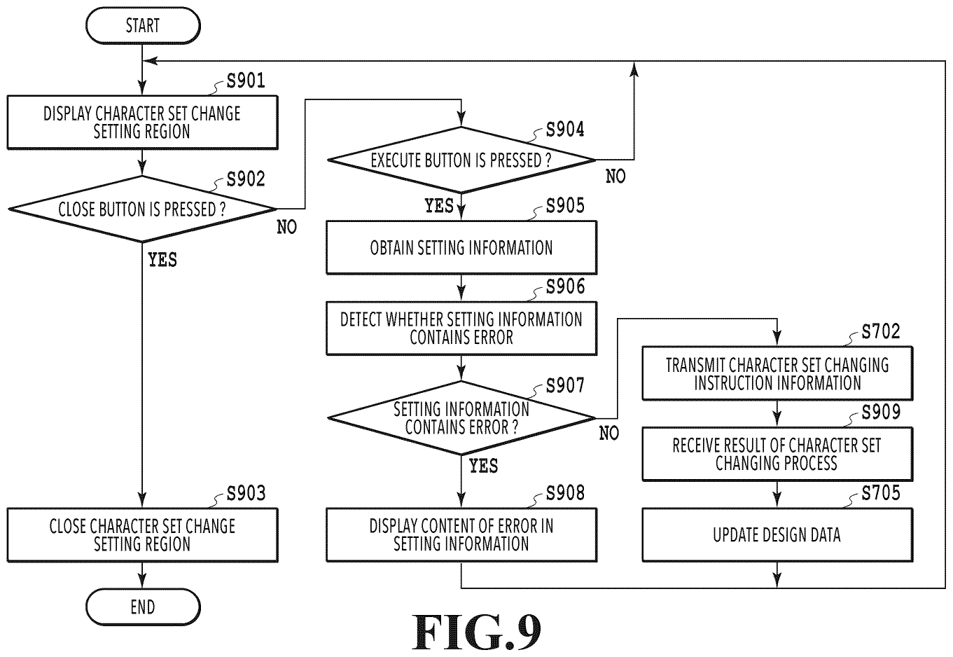

FIG. 9 is a flowchart illustrating an example of an acceptance process of accepting a character set changing instruction and a process of updating the display of the design data to be executed by the poster creation application 300 of the host PC 101 in the present embodiment. The CPU 201 of the host PC 101 implements the processing illustrated in FIG. 9 by reading out the program of the poster creation application 300 stored in the ROM 202 or the HDD 204 to the RAM 203 and executing it. Note that the functions of some or all of the steps in FIG. 9 may be implemented with hardware, such as an application-specific integrated circuit (ASIC) or an electronic circuit. The symbol “S” in the description of each process means a step in the flowchart (the same applies to the other flowcharts herein).

Also, the processing illustrated in FIG. 9 is started in response to a press on the character set change button 606 provided on the editing screen of the poster creation application 300. The flow illustrated in FIG. 9 includes S702 and S705 illustrated in FIG. 7. The processes of S901 to S908 illustrated in FIG. 9 are included in the process of S701 illustrated in FIG. 7.

In S901, the CPU 201 displays the character set change setting region on the editing screen of the poster creation application 300 with the display control component 301.

In S902, the CPU 201 determines whether the close button for accepting an instruction to close the character set change setting region with the operation component 302. If determining that the close button is pressed (Yes) with the operation component 302, the CPU 201 proceeds to S903. If determining that the close button is not pressed (No) with the operation component 302, the CPU 201 proceeds to S904.

In S903, the CPU 201 closes the character set change setting region displayed on the editing screen of the poster creation application 300 with the display control component 301, and terminates the flow.

In S904, the CPU 201 determines with the operation component 302 whether the execute button provided in the character set change setting region, which accepts transmission of character set changing instruction information, is pressed. If determining that the execute button provided in the character set change setting region is pressed (Yes) with the operation component 302, the CPU 201 proceeds to S905. If determining that the execute button provided in the character set change setting region is not pressed (No) with the operation component 302, the CPU 201 returns to S901.

In S905, the CPU 201 obtains setting information indicating the contents of the settings in the character set change setting region with the operation component 302, and proceeds to S906. The setting information obtained in S905 includes font size unifying instruction information and font size varying instruction information.

In S906, the CPU 201 detects whether the setting information obtained in S905 contains an error with the operation unit 302, and proceeds to S907.

In S907, the CPU 201 determines whether the setting information obtained in S905 contains an error with the operation component 302 based on the result of the error detection executed in S906. Specifically, the CPU 201 determines that the setting information obtained in S905 contains an error with the operation component 302 if the setting information obtained in S905 has no font size unifying instruction set in the font size unifying instruction information and no font size varying instruction set in the font size varying instruction information.

The CPU 201 determines that the setting information obtained in S905 contains no error with the operation component 302 if the setting information obtained in S905 has a font size unifying instruction set in the font size unifying instruction information or a font size varying instruction set in the font size varying instruction information.

In S907, the CPU 201 proceeds to S908 if determining that the setting information obtained in S905 contains an error (Yes) with the operation component 302, and proceeds to S702 if determining that the setting information obtained in S905 contains no error (No) with the operation component 302.

In S908, the CPU 201 displays the content of the error in the character set change setting region with the display control component 301, and returns to S901. For example, in S908, the CPU 201 displays a dialogue box including an error message such as “No setting item is selected.” with the display control component 301.

In S702, the CPU 201 transmits character set changing instruction information to the service server 102 with the data transmission component 303, and proceeds to S909. The character set changing instruction information in the present embodiment includes font size unifying instruction information and font size varying instruction information. Also, the character set changing instruction information includes an identification ID for identifying the design data currently edited on the poster creation application 300 of the host PC 101 in the design database 321.

In S909, the CPU 201 receives the result of the character set changing process corresponding to the character set changing instruction information transmitted by the data transmission component 303 in S702 from the service server 102 with the data reception component 304, and proceeds to S705. That is, the process of S909 corresponds to the process of S704.

In S705, the CPU 201 updates the currently edited design data displayed on the editing screen of the poster creation application with the display control component 301 based on the result of the character set changing process received in S909 by the data reception component 304, and returns to S901. Specifically, in S705, the CPU 201 replaces the currently edited design data with the design data after the character set changing process with the display control component 301. Note that the CPU 201 can hold the currently edited design data and load the design data after the character set changing process. The CPU 201 may then display both the currently edited design data and the design data after the character set changing process on the editing screen of the poster creation application with the display control component 301. Alternatively, instead of displaying the design data after the character set changing process on the editing screen of the poster creation application, the CPU 201 may transmit that design data directly to a printer (not illustrated) and cause it to print the design data.

### Flow of Processing by Service Server 102

FIG. 10 is a flowchart illustrating an example of the character set changing process to be executed by the service server 102 in the present embodiment. The flow illustrated in FIG. 10 includes S704 illustrated in FIG. 7. S1001 to S1009 illustrated in FIG. 10 are included in S703 illustrated in FIG. 7.

The CPU 211 implements the processing illustrated in FIG. 10 by reading out control programs stored in the ROM 212 and the HDD 214 to the RAM 213 and executing them. Also, the processing illustrated in FIG. 10 is started in response to the data reception unit 312 of the service server 102 receiving character set changing instruction information from the poster creation application 300 of the host PC 101.

In S1001, with the to-be-emphasized element specification unit 314, the CPU 211 specifies the design purpose of the design data corresponding to the character set changing instruction information received by the data reception component 312. The design purpose refers to the intended use for which the design data is created, such as for advertising an event, promoting sales, or raising awareness. In S1001, the to-be-emphasized element specification unit 314 utilizes the multimodal large language model 322 to specify the design purpose. In S1001, the to-be-emphasized element specification unit 314 generates a prompt for causing the multimodal large language model 322 to estimate the design purpose. Specifically, the to-be-emphasized element specification unit 314 generates a prompt as below.

“Estimate and output the purpose of this design within 20 characters.”

Also, the to-be-emphasized element specification unit 314 obtains a rendered image generated by rendering the design data. The to-be-emphasized element specification unit 314 inputs the rendered image of the design data and a prompt as the above into the multimodal large language model 322 to obtain the result of estimation of the design purpose (purpose information). For example, the to-be-emphasized element specification unit 314 can input the rendered image of the design data illustrated in FIG. 8A and a prompt as the above into the multimodal large language model 322 to obtain text as below as the result of estimation of the design purpose.

“Advertisement for a year-end clearance sale”

The to-be-emphasized element specification unit 314 can specify the design data of the design data based on the result of estimation of the design purpose obtained by inputting the generated prompt and the rendered image of the design data into the multimodal large language model 322.

Note that the method of estimating the design purpose is not limited to the method described above. For example, the to-be-emphasized element specification unit 314 may add text included in the design data to a first prompt being the above-described prompt for estimating the design purpose to generate a second prompt. The to-be-emphasized element specification unit 314 may then input the image included in the design data, instead of the rendered image of the design data, and the second prompt into the multimodal large language model 322 to obtain the result of estimation of the design purpose.

In S1002, the to-be-emphasized element specification unit 314 obtains a text object included in the design data, and proceeds to S1003.

In S1003, the CPU 211 changes the font size of all of the elements of the text included in the text object obtained in S1002 to an default font size with the character set changing unit 315. The default font size is the maximum font size for all of the elements of the text included in the text object to fit within the region provided to the text object in a case of setting the font size of all of those elements to one value within the text object.

The default font size can be derived by Equation 1 below. Note that “/” in the following equation means dividing the value preceding “/” by the value following “/.”

$$default font size = √ ( area of region provided to text \text{object/number} of characters in text included in text object ) \qquad Equation 1$$

For example, in a case where the size of the region provided to the text object is (500, 60) and all of the characters in the text included in the text object are “ABC PRESENTS,” the default font size is derived to be equal to √(500×60/12)=50.

Note that, in a case where the unit of the size of the text region is px (pixels), Equation 2 below can be used to convert the unit of the default font size into pt (points).

$$pt ( points ) = px \times 72 / DPI ( Dots Per Inch ) \qquad Equation 2$$

DPI is a numerical value indicating the image resolution, and a value of 96 or 300 is used. Then, in the text object data table for the obtained text object, the font size of all characters is changed to the derived default font size. Note that the method of deriving the default font size is not limited to the method described above. For example, Equation 3 below may be used on the assumption that a line break will be inserted into the text included in the text object within the text region after each word.

$$default font size = √ ( ( area of text region ) / ( number of characters in text included in text object \times number of words in the text ) ) \qquad Equation 3$$

In S1004, the CPU 211 determines whether the character set changing instruction information includes a font size varying instruction with the to-be-emphasized element specification unit 314. If determining in S1003 that the character set changing instruction information includes a font size varying instruction (Yes) with the to-be-emphasized element specification unit 314, the CPU 211 proceeds to S1005. If determining in S1003 that the character set changing instruction information does not include a font size varying instruction (No) with the to-be-emphasized element specification unit 314, the CPU 211 proceeds to S1009.

In S1005, the CPU 211 specifies the elements to be emphasized among the elements of the text included in the text object obtained in S1002 with the to-be-emphasized element specification unit 314.

As for the method of specifying the elements to be emphasized (hereinafter referred to as “to-be-emphasized elements” or “to-be-emphasized word”), the multimodal large language model 322 is used. Specifically, the to-be-emphasized element specification unit 314 generates a prompt indicating the design purpose obtained in S1001 and a prompt for causing the multimodal large language model 322 to estimate the to-be-emphasized elements based on the text included in the text object. For example, the to-be-emphasized element specification unit 314 generates a prompt as below in a case where the text object 812 illustrated in FIG. 8A has been obtained from the design data in S1002. Note that the present embodiment will be described based on an example in which the to-be-emphasized element specification unit 314 specifies the to-be-emphasized elements among the elements of the text included in the text object on a word-by-word basis.

“I am creating a design intended to advertise a year-end clearance sale. In the following text, which words should be emphasized and displayed? Classify the degree of emphasis for each word as “high” or “low.”

By inputting a prompt as the above into the multimodal large language model 322, a result of estimation of the to-be-emphasized elements as below (to-be-emphasized element information) is obtained.

“High: Year-End, Clearance” “Low: Sale”

Also, the to-be-emphasized element specification unit 314 generates a prompt as below in a case where a text object 811 illustrated in FIG. 8A has been obtained from the design data in S1002.

“I am creating a design intended to advertise a year-end clearance sale. In the following text, which words should be emphasized and displayed? Classify the degree of emphasis for each word as “high” or “low.” “ABC PRESENTS”

By inputting a prompt as the above into the multimodal large language model 322, a result of estimation of the to-be-emphasized elements as below is obtained.

“High: none” “Low: ABC, PRESENTS”

In a case where there is no word whose degree of emphasis is classified as “high” or low“ as in the above, the to-be-emphasized element specification unit 314 determines that the text includes no word to be emphasized.

Now, other examples of the result of estimation of the to-be-emphasized elements will be described. For example, the to-be-emphasized element specification unit 314 generates a prompt as below for text “All items in the store 30% OFF.”

“I am creating a design intended to advertise a year-end clearance sale. In the following text, which words should be emphasized and displayed? Classify the degree of emphasis for each word as “high” or “low.” “All items in the store 30% OFF”

By inputting a prompt as the above into the multimodal large language model 322, a result of estimation of the to-be-emphasized elements as below is obtained.

“High: 30%, OFF” “Low: All, Items, in, the, Store”

Also, in a case where the design purpose is to “raise awareness of traffic safety,” the to-be-emphasized element specification unit 314 can generate a prompt as below for text “Yield to pedestrians at the crosswalk.”

“I am creating a design intended to raise the awareness of traffic safety. In the following text, which words should be emphasized and displayed? Classify the degree of emphasis for each word as “high” or “low.” “Yield to pedestrians at the crosswalk.”

By inputting a prompt as the above into the multimodal large language model 322, a result of estimation of the to-be-emphasized elements as below is obtained.

“High: Yield to Pedestrians” “Low: at the Crosswalk”

As described above, the to-be-emphasized element specification unit 314 generates a prompt based on the design purpose specified in S1001 and the text object obtained in S1002. The to-be-emphasized element specification unit 314 can then specify the to-be-emphasized elements from the text based on the result of estimation of the to-be-emphasized elements obtained by inputting the generated prompt into the multimodal large language model 322.

Note that the method of specifying the to-be-emphasized elements is not limited to the method described above. For example, the administrator in charge of the service server 102 may store design purposes and to-be-emphasized elements associated with the design purposes in the design database 321 in advance. Then, the to-be-emphasized element specification unit 314 may determine whether the to-be-emphasized elements associated with the design purpose specified in S1001 are included in the text object obtained in S1002 to specify the to-be-emphasized elements.

In S1006, the CPU 211 changes the font size of all of the elements of the text included in the text object obtained in S1002 with the character set changing unit 315 based on the to-be-emphasized elements specified in S1005. Specifically, the character set changing unit 315 obtains the font size of the characters of the words other than the to-be-emphasized words in the text object data table for the text object obtained in S1002. The character set changing unit 315 then decrements the font size of the characters of the words other than the to-be-emphasized words by 1 pt (decremented font size). Thereafter, the character set changing unit 315 changes the font size of the characters of the to-be-emphasized words to a font size that is 1.5 times larger than the decremented font size (emphasized font size).

For example, with the text object 812 illustrated in FIG. 8A, the character set changing unit 315 changes the font size of “Sale” to 21 pt in a case where the decremented font size of “Year-End” and “Clearance” is 14 pt. Note that the amount by which to decrement the font size does not need to be 1 pt. For example, the amount by which to decrement the font size may be 2 pt or 0.5 pt. Also, the emphasized font size does not need to be 1.5 times larger than the decremented font size as long as it is a larger font size than the decremented font size. For example, the emphasized font size may be two times larger than the decremented font size or larger by 4 pt than the decremented font size.

In S1007, the CPU 211 arranges all of the elements whose font size has been changed in S1006 within the region provided to the text object with the character set changing unit 315. Specifically, the character set changing unit 315 sequentially arranges the words with the decremented font size and the words with the emphasized font size within the region provided to the text object.

In S1008, the CPU 211 determines whether all of the elements arranged in S1007 fit within the region provided to the text object obtained in S1002 with the character set changing unit 315. For example, in S1008, the character set changing unit 315 determines that not all of the elements fit within the text region if the attempt to arrange all of the elements within the text region in S1007 ends up arranging some or all of the elements outside the text region. On the other hand, if all of the elements are arranged within the text region, the character set changing unit 315 determines in S1008 that all of the elements fit within the text region.

Note that the method of determining whether all of the elements fit within the text region is not limited to the one described above. For example, the character set changing unit 315 may derive the area of a region that is necessary for the text formed of the elements with the decremented font size and the elements with the emphasized font size. Then, if the derived area is larger than the area of the region provided to the text object obtained in S1002, the character set changing unit 315 may determine that not all of the elements fit within the text region.

As a specific example, the area of the above-mentioned region necessary for the text can be derived as (decremented font size\hat{ }2×number of characters forming words other than to-be-emphasized words)+(emphasized font size\hat{ }2×number of characters forming to-be-emphasized words).

If determining in S1008 that all of the elements fit within the text region (Yes) with the character set changing unit 315, the CPU 211 proceeds to S1009. If determining in S1008 that not all of the elements fit within the text region (No) with the character set changing unit 315, the CPU 211 returns to S1006.

In S1009, the CPU 211 determines whether all of the text objects in the design data have been processed with the character set changing unit 315. If determining in S1009 that all of the text objects have been processed (Yes) with the character set changing unit 315, the CPU 211 proceeds to S704. If determining in S1009 that there is still a text object or objects yet to be processed in the design data (No) with the character set changing unit 315, the CPU 211 returns to S1002.

In S704, the CPU 211 transmits the result of the character set changing process to the poster creation application 300 of the host PC 101 with the data transmission unit 311, and terminates the flow.

In the example illustrated in FIGS. 8A and 8B, the text object 812 and a text object 813 illustrated in FIG. 8A are changed to a text object 822 and a text object 823 illustrated in FIG. 8B, respectively. Here, the to-be-emphasized elements in the text included in each text object are displayed in a font size larger than the font size of the elements other than the to-be-emphasized elements. Also, as can be seen from the text object 811 illustrated in FIG. 8A and a text object 821 illustrated in FIG. 8B, in a case it is determined that there is no to-be-emphasized element among the elements of the text, all of the elements of the text are displayed in one font size.

According to the present embodiment, the service server automatically specifies to-be-emphasized elements from among the elements of the text included in the text objects included in design data and, based on the specified to-be-emphasized elements, changes the character set of the to-be-emphasized elements on a word-by-word basis. In this way, when the design data is displayed on the editing screen of the poster creation application, the to-be-emphasized elements are automatically specified from the elements of the text included in the text objects included in the design data and displayed. This makes it possible to improve the visual perceptibility of the to-be-emphasized elements in the text when the design data is displayed without accepting input of the elements to be emphasized from the user.

The present embodiment has been described based on an example in which the character set of the elements of text is changed to make to-be-emphasized elements in the text larger in size than the elements other than the to-be-emphasized elements in order to improve the visual perceptibility of the to-be-emphasized elements in the text. Specifically, the present embodiment has been described based on an example in which, in the process of changing the font size in S1006 described above, the font size of the to-be-emphasized words is changed to a larger font size than the font size of the words other than the to-be-emphasized words, but the character set changing process is not limited to this. For example, the process of changing the font size in S1006 described above may be replaced with a process of changing a different type of character set to emphasize the to-be-emphasized elements relative to the elements other than the to-be-emphasized elements. Specifically, the process of changing the font size may be replaced with a process of changing the font color, the font type, the bolding decoration, the italicizing decoration, or the underling decoration. This provides options for the method of emphasizing the to-be-emphasized elements in the text relative to the elements other than the to-be-emphasized elements. Accordingly, it is possible to effectively emphasize elements in text according to the type or design purpose of the design data.

### Second Embodiment

The first embodiment has been described based on an example in which to-be-emphasized elements are automatically specified from among the elements of the text included in a text object or objects included in design data and, based on the specified to-be-emphasized elements, the character set of these elements is changed on a word-by-word basis. Specifically, in the first embodiment, the character set of the elements of the text included in all of the text objects included in design data is changed. However, there are users who wish to change the character set of the elements of the text included in a text object or objects selected as targets from among the text objects included in design data. In view of this, in a second embodiment, a description will be given of an example in which the character set of the elements of the text included in a text object or objects selected as targets from among text objects included in design data is changed. Note that the basic configurations of the host PC and the service server in the present embodiment are similar to the configurations in the first embodiment, and detailed description thereof will therefore be omitted. The difference from the first embodiment will be described below.

### Processing Sequence

In the present embodiment, in S701 in FIG. 7, the operation component 302 of the poster creation application 300 accepts a character set changing instruction from the user through the display and operation I/F 206. Character set changing instruction information in the present embodiment further includes information indicating whether to set a selected text object or objects as targets for a character set changing process (hereinafter referred to as “processing target indicating information”). Also, in a case where the processing target indicating information includes an instruction to perform a character set changing process on the text object or objects selected therein, the character set changing instruction information includes information indicating the selected text object or objects.

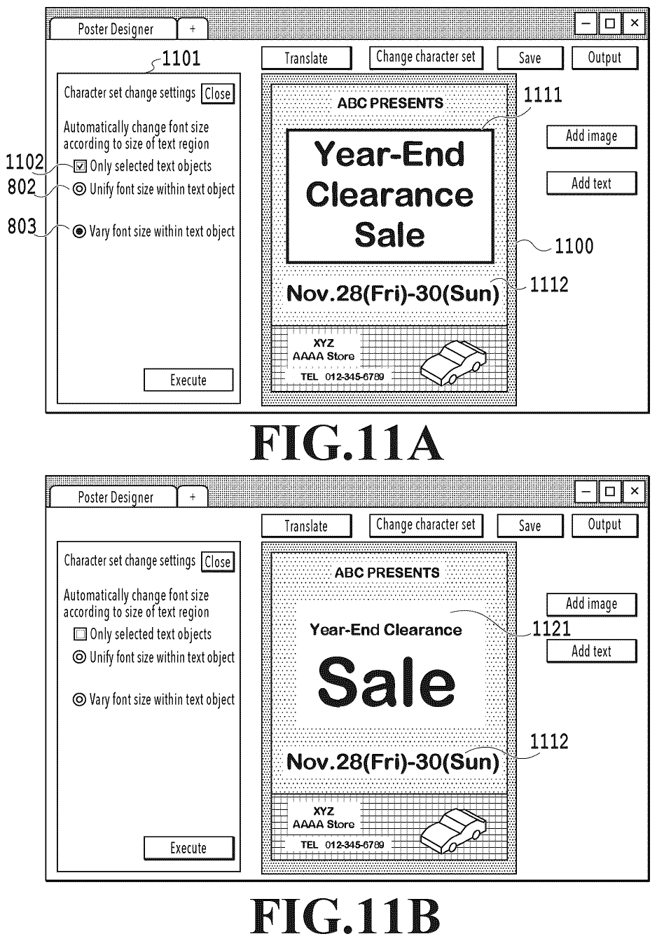

FIGS. 11A and 11B are diagrams illustrating an example of the editing screen of the poster creation application 300 with a character set change setting region 1101 displayed in the present embodiment. As illustrated in FIG. 11A, the character set change setting region 1101 is provided with a setting item 1102 capable of accepting an instruction to set a text object or objects selected on the editing screen as targets for a character set changing process. FIG. 11A illustrates a state where the setting item 1102 provided in the character set change setting region 1101 is selected and a text object 1111 is selected as a target for a character set changing process. Also, FIG. 11A illustrates a state where the setting item 802 is not selected and the setting item 803 is selected.

In the case where the setting item 1102 is selected, then in S701 in FIG. 7, the operation component 302 of the poster creation application 300 accepts selection of one or more objects among the objects included in the design data displayed in a design editing region 1100. The present embodiment will be described based on an example in which the object type which the operation component 302 can accept in the case where the setting item 1102 is selected is text. That is, in the case where the setting item 1102 is selected, the operation component 302 can accept selection of text objects from among the objects included in the design data but does not accept selection of objects of the types other than text.

Note that in the case where the setting item 1102 is selected, the operation component 302 may accept objects of types other than text such as images or figures. In this case, in response to the operation component 302 accepting selection of an object of a type other than text, the display control component 301 may display a warning message in a dialogue box warning the user to select an object or objects whose object type is text.

### Flow of Processing by Host PC 101

In the present embodiment, in S905 in FIG. 9, the CPU 201 obtains setting information indicating the contents of the settings in the character set change setting region 1101 with the operation component 302. The setting information in the present embodiment includes processing target indicating information. Alternatively, the setting information in the present embodiment further includes information indicating the selected text object or objects. Note that the setting information in the present embodiment includes font size unifying instruction information and font size varying instruction information.

In the present embodiment, in S906, the CPU 201 detects whether the setting information obtained in S905 contains an error with the operation unit 302. Specifically, if the setting information obtained in S905 includes neither a font size unifying instruction nor a font size varying instruction, then in S906, the CPU 201 determines that the setting information obtained in S905 contains an error with the operation component 302.

Also, the setting information obtained in S905 may include an instruction to set the text object or objects selected on the editing screen as targets for a character set changing process, and does not include information indicating the text object or objects to be subjected to the character set changing process. In this case, in S906, the CPU 201 determines that the setting information obtained in S905 contains an error with the operation component 302.

In the present embodiment, in S908 in FIG. 9, the CPU 201 displays the content of the setting value error in the character set change setting region with the display control component 301. For example, the setting information obtained in S905 may include an instruction to set the text object or objects selected on the editing screen as targets for a character set changing process, and does not include information indicating the text object or objects to be subjected to the character set changing process. In this case, in S908, the CPU 201 displays an error message such as “No character set changing target is selected.” in a dialogue box with the display control unit 301.

### Flow of Processing by Service Server 102

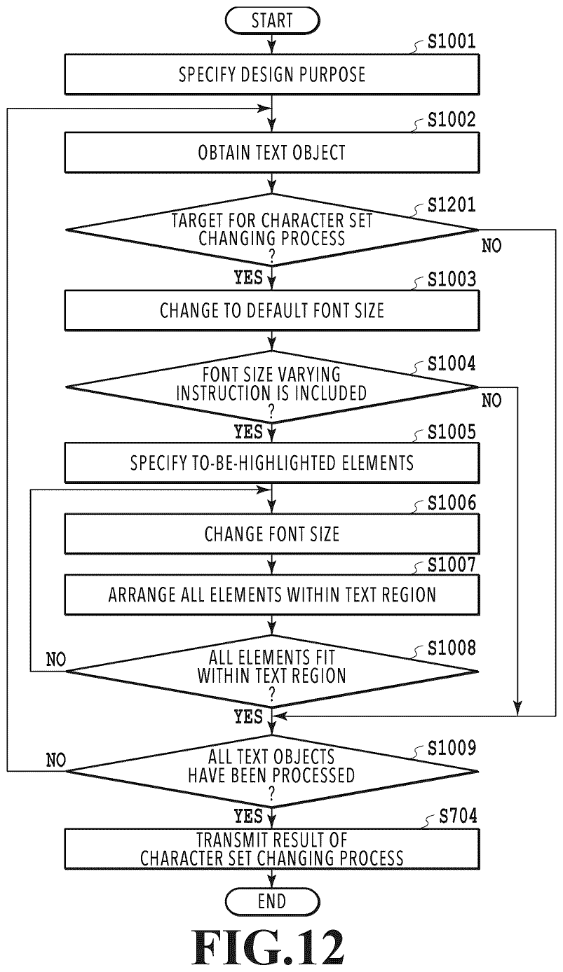

FIG. 12 is a flowchart describing processing to be executed by the service server 102 in the present embodiment. S1001 to S1009 and S1201 illustrated in FIG. 12 are included in S703 illustrated in FIG. 7. The processing illustrated in FIG. 12 is started in response to the data reception unit 312 of the service server 102 receiving character set changing instruction information from the poster creation application 300 of the host PC 101. The difference between the flowchart in the present embodiment (FIG. 12) and the flowchart in the first embodiment (FIG. 10) will be described below. As compared to the flow in the flowchart illustrated in FIG. 10, the flowchart illustrated in FIG. 12 additionally includes the process of S1201.

In S1201, with the to-be-emphasized element specification unit 314, the CPU 211 determines whether the text object obtained in S1002 is designated as a target for a character set changing process in the character set changing instruction information.

If determining in S1201 that the text object obtained in S1002 is designated as a target for a character set changing process (Yes) with the to-be-emphasized element specification unit 314, the CPU 211 proceeds to S1003. If determining in S1201 that the text object obtained in S1002 is not designated as a target for a character set changing process (No) with the to-be-emphasized element specification unit 314, the CPU 211 proceeds to S1009. That is, the service server 102 does not execute the processes of S1003 to S1008 on text objects that are not designated as a target for a character set changing process. Specifically, text objects that are not designated as a target for a character set changing process are not subjected to the process of changing the font size to the default font size in S1003, the process of specifying the to-be-emphasized elements in S1005, the process of changing the character set of the to-be-emphasized elements in S1006, and so on.

In the example illustrated in FIGS. 11A and 11B, a character set changing process is performed on the text object 1111 illustrated in FIG. 11A. By performing the character set changing process, the text object 1111 illustrated in FIG. 11A is converted into a text object 1121 illustrated in FIG. 11B. On the other hand, a text object 1112, which is not a target for the character set changing process, is not subjected to the character set changing process.

According to the present embodiment, it is possible to change the character set of the elements of the text included in a text object or objects selected as targets from among the text objects included in design data. That is, a character set changing process is executed on a text object or objects selected by the user and not executed on the text objects not selected by the user. This improves the usability of the poster creation application.

### Third Embodiment

The first embodiment has been described based on an example in which to-be-emphasized elements are automatically specified from among the elements of the text included in a text object or objects included in design data and, based on the specified to-be-emphasized elements, the character set of these elements is changed on a word-by-word basis. However, there is a possibility that the result of the character set changing process is not a result expected by the user. In view of this, in a third embodiment, a description will be given of an example in which design data after a character set changing process is used to re-specify the to-be-emphasized elements to execute a character set changing process again. Note that the basic configurations of the host PC and the service server in the present embodiment are similar to the configurations in the first embodiment, and detailed description thereof will therefore be omitted. The difference from the first embodiment will be described below.

### Flow of Processing by Host PC 101

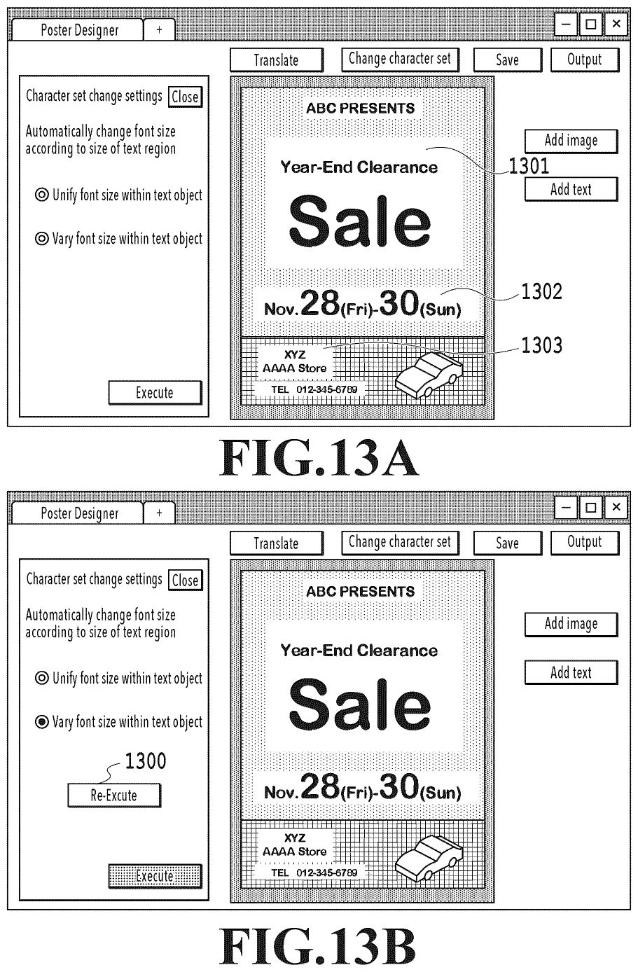

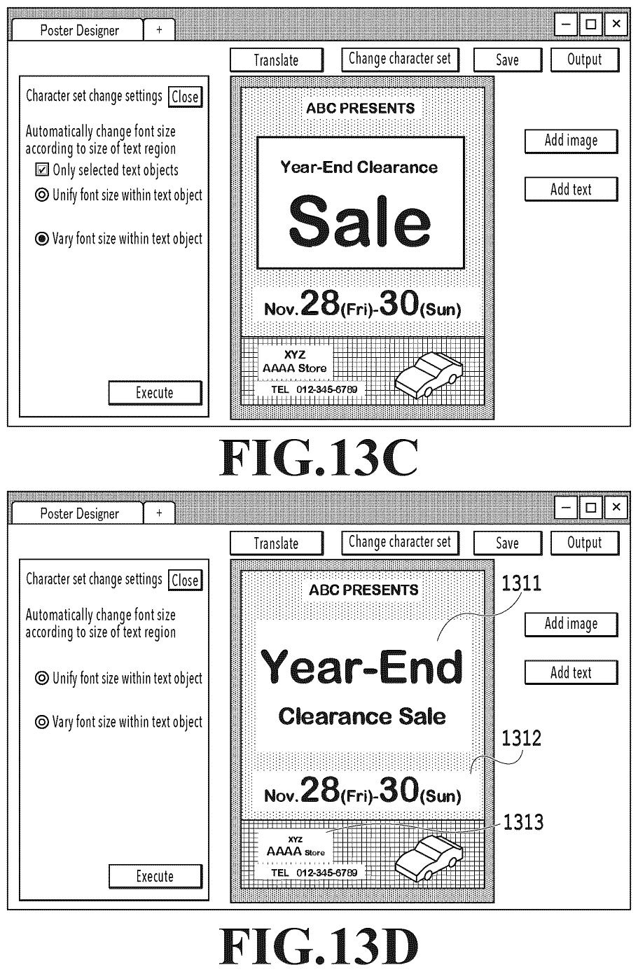

FIGS. 13A to 13D are diagrams illustrating an example of the editing screen of the poster creation application 300 for describing a flow of the re-execution of a character set changing process. FIG. 13A is a diagram illustrating the editing screen of the poster creation application 300 with design data displayed as the result of a character set changing process.

The flow of the processing by the host PC 101 in the present embodiment is similar to the flow illustrated in FIG. 9 (first embodiment). In the present embodiment, in S904 in FIG. 9, the CPU 201 determines whether the execute button provided in the character set change setting region is pressed with the operation component 302.

If determining in S904 that the execute button provided in the character set change setting region is pressed (Yes) with the operation component 302, the CPU 201 proceeds to S905. If determining in S904 that the execute button provided in the character set change setting region is not pressed (No) with the operation component 302, the CPU 201 returns to S901.

Note that, in the present embodiment, a process of displaying a re-execute button in the character set change setting region may be added after S705 illustrated in FIG. 9. The re-execute button in the present embodiment is a button for accepting an instruction to re-execute a character set changing process. The re-execution of a character set changing process will be described later.

In this case, in S904 after displaying the re-execute button, the CPU 201 may further determine whether the re-execute button provided in the character set change setting region is pressed with the operation component 302. Specifically, if determining in S904 after displaying the re-execute button that the re-execute button provided in the character set change setting region is pressed (Yes) with the operation component 302, the CPU 201 proceeds to S905. If determining in S904 after displaying the re-execute button that the re-execute button provided in the character set change setting region is not pressed (No) with the operation component 302, the CPU 201 returns to S901. FIG. 13B is a diagram illustrating the editing screen of the poster creation application 300 with a re-execute button 1300 displayed in the character set change setting region. Note that character set changing instruction information to be transmitted by the data transmission component 303 in response to a press on the re-execute button may include information indicating an instruction to re-execute a character set changing process.

### Flow of Processing by Service Server 102

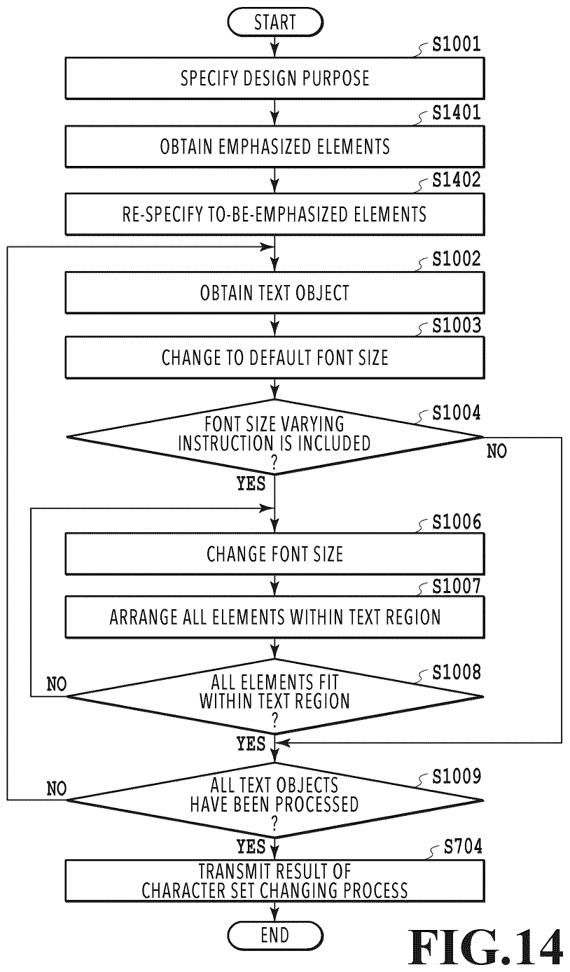

FIG. 14 is a flowchart illustrating an example of processing to be executed by the service server 102 in the present embodiment. A flow of the re-execution of a character set changing process by the service server 102 will now be described with reference to FIG. 14.

S1001 to S1004, S1006 to S1009, S1401, and S1402 illustrated in FIG. 14 are included in S703 illustrated in FIG. 7. The processing illustrated in FIG. 14 is started in response to the data reception unit 312 of the service server 102 receiving character set changing instruction information from the poster creation application 300 of the host PC 101. The difference between the flowchart in the present embodiment (FIG. 14) and the flowchart in the first embodiment (FIG. 10) will be described below.

As compared to the flow in the flowchart illustrated in FIG. 10, the flowchart illustrated in FIG. 14 does not include the process of S1005 and additionally includes the processes of S1401 and S1402.

In S1401, the CPU 211 obtains the elements that have been emphasized in all of the text objects included in the design data (hereinafter referred to as “emphasized elements” or “emphasized words”) with the to-be-emphasized element specification unit 314. Specifically, in S1401, the CPU 211 obtains the word or words in the text object data table for each text object included in the design data that include characters with the largest font size as emphasized words with the to-be-emphasized element specification unit 314.

Note that the method of obtaining the emphasized elements is not limited to the method described above. For example, the to-be-emphasized element specification unit 314 may store the emphasized elements in the design database 321 individually for each text object in advance. The to-be-emphasized element specification unit 314 may then obtain the emphasized elements from the design database 321. Alternatively, the to-be-emphasized element specification unit 314 may obtain an element whose color, font type, bolding decoration, italicizing decoration, or underling decoration, instead of the element's size, is different from that of the other elements as an emphasized element.

In S1402, the CPU 211 re-specifies the to-be-emphasized elements in the text with the to-be-emphasized element specification unit 314. The multimodal large language model 322 is used for the re-specification of the to-be-emphasized elements. In S1402, the CPU 211 generates a prompt for causing the multimodal large language model 322 to re-estimate the to-be-emphasized elements with the to-be-emphasized element specification unit 314 based on the design purpose specified in S1001 and the emphasized elements obtained in S1402.

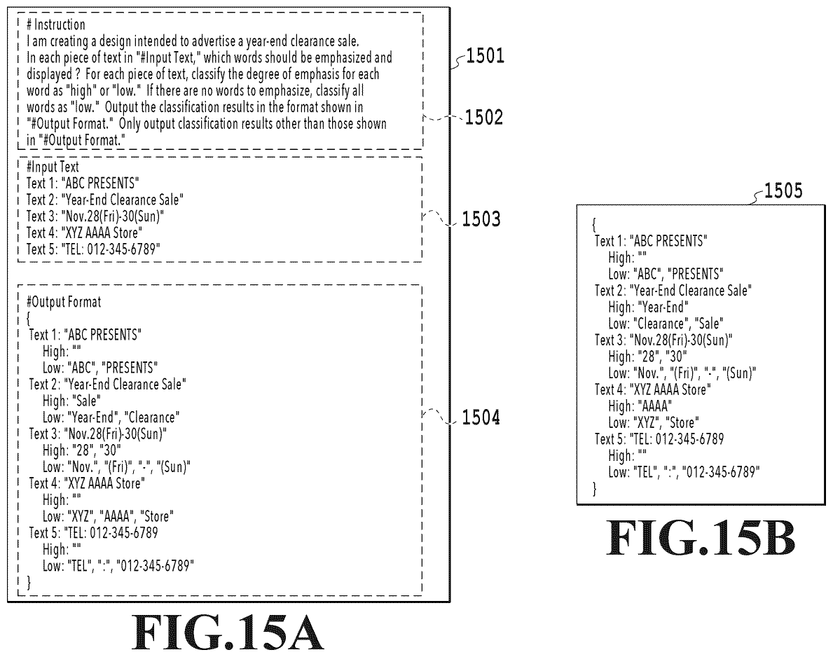

FIGS. 15A and 15B are diagrams illustrating an example of the prompt for causing the multimodal large language model 322 to re-estimate the to-be-emphasized elements and the result of the re-estimation of the to-be-emphasized elements. FIG. 15A is a diagram illustrating a prompt 1501 for re-estimating the to-be-emphasized elements from the result of the character set changing process displayed in FIG. 13A. The prompt 1501 includes an instruction 1502, input text 1503, and an output format 1504. The output format 1504 reflects emphasized words obtained from the result of the character set changing process displayed in FIG. 13A. The instruction 1502 in FIG. 15A includes an instruction to output an output result other than that listed in the output format 1504.

FIG. 15B is a diagram illustrating the result of the re-estimation of the to-be-emphasized elements output by the multimodal large language model 322 in response to input of the prompt 1501 illustrated in FIG. 15A. In a to-be-emphasized element re-estimation result 1505, output to-be-emphasized words that are different from the emphasized words listed in the output format 1504 in FIG. 15A are listed. By causing the multimodal large language model 322 to re-estimate the to-be-emphasized elements as described above, the to-be-emphasized element specification unit 314 can re-specify the to-be-emphasized elements from the elements of the text based on the result of the re-estimation.

Note that the method of re-estimating the to-be-emphasized elements is not limited to the method described above. For example, in the above-described method, it suffices that a to-be-emphasized element different from an emphasized element in at least one text object among all text objects is estimated. Alternatively, a to-be-emphasized element or elements may be re-estimated individually for each text object to estimate to-be-emphasized elements different from the emphasized elements in all text objects.

In the example illustrated in FIGS. 13A, 13B, and 13D, text objects 1301 and 1303 illustrated in FIG. 13A are subjected to a character set changing process again and changed to text objects 1311 and 1313 illustrated in FIG. 13D, respectively. On the other hand, a text object 1302 illustrated in FIG. 13A is not subject to a character set changing process again.

Specifically, in the example illustrated in FIG. 13D, “Year-End” specified as a to-be-emphasized word in S1402 is displayed in a larger size than “Clearance” and “Sale” not specified as to-be-emphasized words in S1402. More specifically, the font size of “Sale” specified as an emphasized word in S1401 and not specified as a to-be-emphasized word in S1402 has been changed to the decremented font size by the character set changing unit 315 in S1006. Also, the font size of “Year-End” not specified as an emphasized word in S1401 and specified as a to-be-emphasized word in S1402 has been changed to the emphasized font size by the character set changing unit 315 in S1006.

In sum, in the example illustrated in FIG. 13D, in S1006, the character set changing unit 315 changes the font size of “Year-End” to emphasize “Year-End” with respect to the words other than “Year-End” among the words in the text including “Sale.” Also, in the example illustrated in FIG. 13D, in S1006, the character set changing unit 315 changes the character set of “Clearance” and “Sale,” which are the words other than “Year-End” among the words in the text, such that “Clearance” and “Sale” are not emphasized with respect to “Year-End.” Specifically, in S1006, the character set changing unit 315 changes the font size of “Year-End” to the emphasized font size, and changes the font size of “Clearance” and “Sale” to the decremented font size, as described above.

According to the present embodiment, for a text object or objects included in design data displayed as the result of a character set changing process on the editing screen of the poster creation application, the to-be-emphasized elements are re-specified under such a condition as to exclude the result, and a character set changing process is then executed. In this way, the design data will be obtained as expected by the user. This improves the usability of the poster creation application.

In the present embodiment, a description has been given of an example in which a character set changing process is re-executed based on information indicating the to-be-emphasized elements in all of the text objects included in design data displayed as the result of a character set changing process on the editing screen of the poster creation application. Note that, as illustrated in FIG. 13C, a character set changing process may be re-executed on a text object or objects selected from among the text objects included in the design data.

### Fourth Embodiment

The first embodiment has been described based on an example in which to-be-emphasized elements are automatically specified from among the elements of the text included in a text object or objects included in design data and, based on the specified to-be-emphasized elements, the character set of these elements is changed on a word-by-word basis. In a fourth embodiment, a description will be given of an example in which, in a case of causing the service server to translate the text of the text objects included in design data, a character set changing process is executed on the result of the translation. Note that the basic configurations of the host PC and the service server in the present embodiment are similar to the configurations in the first embodiment, and detailed description thereof will therefore be omitted. The difference from the first embodiment will be described below.

### Flow of Processing by Host PC 101

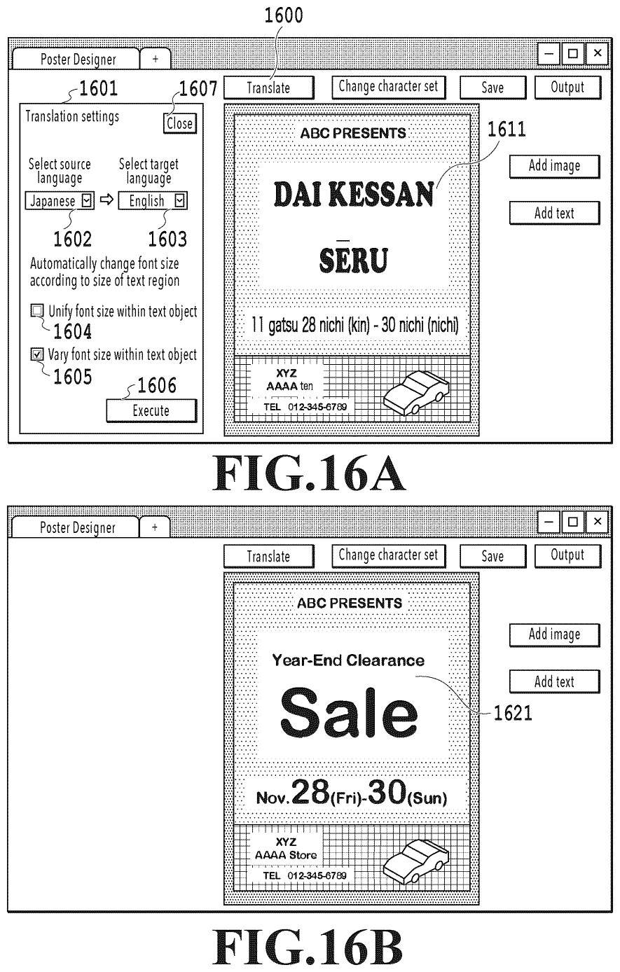

FIGS. 16A and 16B are diagrams illustrating an example of the editing screen of the poster creation application for describing a flow of the execution of a character set changing process involving text translation in the present embodiment. FIG. 16A is a diagram illustrating an example of the editing screen of the poster creation application with a translation setting region 1601 displayed. The translation setting region 1601 is displayed in response to a press on a translate button 1600 in the present embodiment. The translation setting region 1601 is provided with a setting item 1602 capable of setting a source language for translation and a setting item 1603 capable of setting a target language for translation. Also, the translation setting region 1601 is provided with setting items 1604 and 1605. Note that the functions of the setting items 1604 and 1605 are similar to the functions of the setting items 802 and 803 illustrated in FIGS. 8A and 8B, respectively, and description thereof will therefore be omitted.

The translation setting region 1601 is provided with an execute button 1606 and a close button 1607. In response to a press on the execute button 1606, the operation component 302 of the poster creation application 300 accepts a character set changing instruction along with the setting values of the setting items provided in the translation setting region 1601. That is, in response to a press on the execute button 1606, the data transmission component 303 of the poster creation application 300 transmits character set changing instruction information including the contents of the settings in the translation setting region 1601.

In response to a press on the close button 1607, the display control component 301 of the poster creation application 300 closes the translation setting region 1601. FIG. 16A illustrates a state where the setting item 1602 is set to “Japanese” and the setting item 1603 is set to “English.” Also, FIG. 16A illustrates a state where the setting item 1605 is selected.

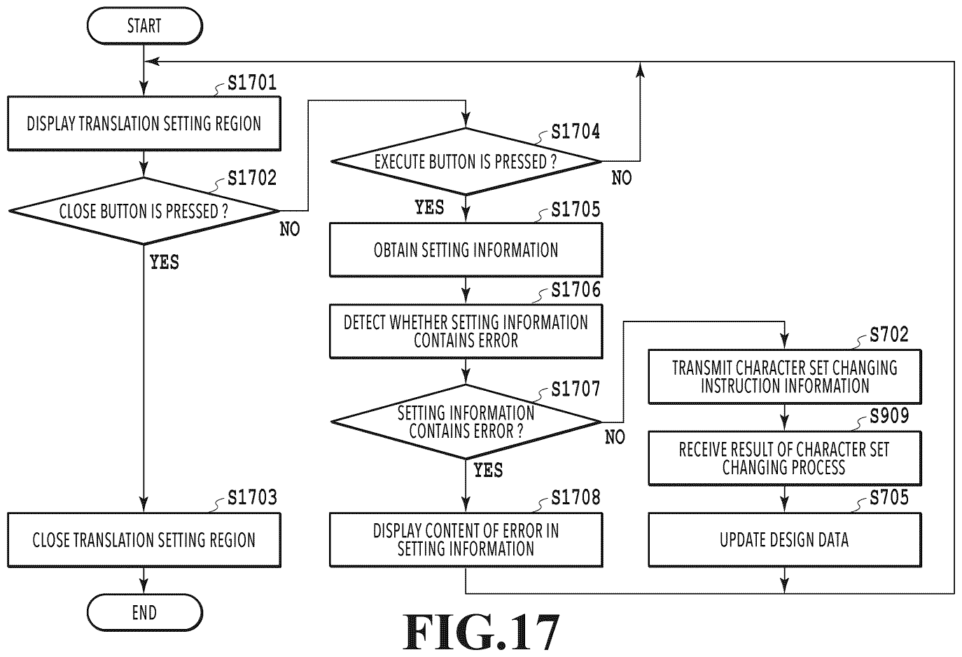

FIG. 17 is a flowchart illustrating an example of an acceptance process of accepting a character set changing instruction and a process of updating the display of design data to be executed by the poster creation application 300 of the host PC 101 in the present embodiment. In the present embodiment, the flow of the processing executed between the host PC 101 and the service server 102 is similar to the flow of the processing illustrated in FIG. 7. The processes of S1701 to S1708 illustrated in FIG. 17 are included in S701 illustrated in FIG. 7. The processing illustrated in FIG. 17 is started in response to a press on the translate button 1600 illustrated in FIG. 16A, for example.

In S1701, the CPU 201 displays the translation setting region 1601 on the editing screen of the poster creation application 300 with the display control component 301, and proceeds to S1702.

In S1702, the CPU 201 determines whether the close button 1607 provided in the translation setting region 1601 is pressed with the operation component 302. If determining in S1702 that the close button 1607 provided in the translation setting region 1601 is pressed (Yes) with the operation component 302, the CPU 201 proceeds to S1703. If determining in S1702 that the close button 1607 provided in the translation setting region 1601 is not pressed (No) with the operation component 302, the CPU 201 proceeds to S1704.

In S1703, the CPU 201 closes the translation setting region 1601 displayed on the editing screen of the poster creation application 300 with the display control component 301, and terminates the flow.

In S1704, the CPU 201 determines whether the execute button 1606 provided in the translation setting region 1601 is pressed with the operation component 302. If determining in S1704 that the execute button 1606 provided in the translation setting region 1601 is pressed (Yes) with the operation component 302, the CPU 201 proceeds to S1705. If determining in S1704 that the execute button 1606 provided in the translation setting region 1601 is not pressed (No) with the operation component 302, the CPU 201 returns to S1701.

In S1705, the CPU 201 obtains setting information indicating the contents of the settings in the translation setting region 1601 with the operation component 302, and proceeds to S1706. The setting information obtained in S1705 includes a text translation instruction. The text translation instruction is an instruction to translate the text included in the text objects included in the design data from a first language into a second language. For example, in a case where a language is set in each of the setting items 1602 and 1603, the text translation instruction may be included in the setting information. Also, in a case where a language is set in the setting item 1602 or 1603, the text translation instruction does not need to be included in the setting information.

Also, the setting information obtained in S1705 includes information indicating the source language for translation and information indicating the target language for translation. Also, the setting information obtained in S1705 includes font size unifying instruction information and font size varying instruction information.

In S1706, the CPU 201 detects whether the setting information obtained in S1705 contains an error with the operation unit 302, and proceeds to S1707.

In S1707, the CPU 201 determines whether the setting information obtained in S1705 contains an error with the operation component 302 based on the result of the error detection executed in S1706. If determining in S1707 that the setting information obtained in S1705 contains an error (Yes) with the operation component 302, the CPU 201 proceeds to S1708. For example, if the setting information obtained in S1705 includes information indicating that a source language for translation or a target language for translation is “not selected,” the CPU 201 determines in S1707 that the setting information contains an error with the operation component 302. If determining in S1707 that the setting information obtained in S1705 contains no error (No) with the operation component 302, the CPU 201 proceeds to S702.

In S1708, the CPU 201 displays the content of the error in the translation setting region 1601 with the display control component 301, and returns to S1701. For example, the display control component 301 displays a dialogue box including an error message such as “No target language for translation is selected.”

In the present embodiment, in S702, the CPU 201 transmits character set changing instruction information to the service server 102 with the data transmission component 303, and proceeds to S909. The character set changing instruction information in the present embodiment includes font size unifying instruction information and font size varying instruction information. Also, the character set changing instruction information in the present embodiment includes an identification ID for identifying the design data currently edited on the poster creation application 300 of the host PC 101 in the design database 321. Further, the character set changing instruction information in the present embodiment includes a text translation instruction, information indicating the source language for translation, and information indicating the target language for translation.

In the present embodiment, in S909, the CPU 201 receives the result of the character set changing process corresponding to the character set changing instruction information transmitted by the data transmission component 303 in S702 from the service server 102 with the data reception component 304, and proceeds to S705. The process of S909 corresponds to the process of S704.

In the present embodiment, in S705, the CPU 201 updates the currently edited design data displayed on the editing screen of the poster creation application with the display control component 301 based on the result of the character set changing process received in S909 by the data reception component 304. The CPU 201 then returns to S1701 with the display control component 301. In S705, the CPU 201 replaces the currently edited design data with the design data after the character set changing process with the display control component 301. Note that the CPU 201 can hold the currently edited design data and load the design data after the character set changing process involving text translation. The CPU 201 may then display both the currently edited design data and the design data after the character set changing process involving text translation on the editing screen of the poster creation application with the display control component 301. Alternatively, instead of displaying the design data after the character set changing process involving text translation on the editing screen of the poster creation application, the CPU 201 may transmit that design data directly to a printer and cause it to print the design data.

### flow of Processing by Service Server 102

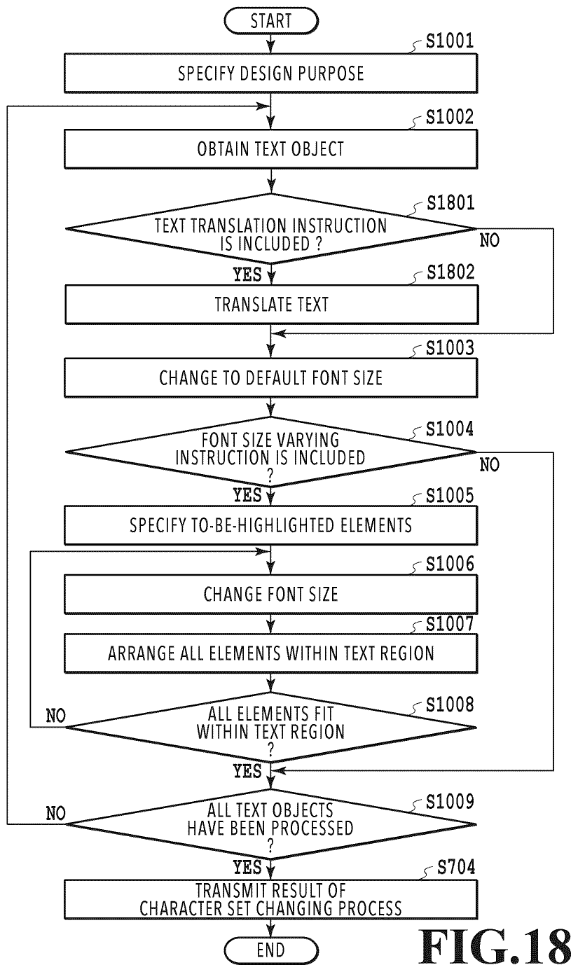

FIG. 18 is a flowchart illustrating an example of the character set changing process to be executed by the service server 102 in the present embodiment. The flow illustrated in FIG. 18 includes S704 illustrated in FIG. 7. S1001 to S1009, S1801, and S1802 illustrated in FIG. 18 are included in S703 illustrated in FIG. 7. The processing illustrated in FIG. 18 is started in response to the data reception unit 312 of the service server 102 receiving character set changing instruction information from the poster creation application 300 of the host PC 101. The difference between the flowchart in the present embodiment (FIG. 18) and the flowchart in the first embodiment (FIG. 10) will be described below. As compared to the flow in the flowchart illustrated in FIG. 10, the flowchart illustrated in FIG. 18 additionally includes the processes of S1801 and S1802.

In S1801, the CPU 211 determines whether the character set changing instruction information includes a text translation instruction with the text translation unit 313. If determining in S1801 that the character set changing instruction information includes a text translation instruction (Yes) with the text translation unit 313, the CPU 211 proceeds to S1802. If determining in S1801 that the character set changing instruction information includes no text translation instruction (No) with the text translation unit 313, the CPU 211 proceeds to S1003.

In S1802, the CPU 211 translates the text included in the text object obtained in S1002 with the text translation unit 313, and proceeds to S1003. The multimodal large language model 322 is used for the text translation. The text translation unit 313 generates a prompt for causing the multimodal large language model 322 to execute the translation. For example, the text translation unit 313 generates a prompt as below in a case where a text object 1611 illustrated in FIG. 16A is obtained.

“Translate the following text.”

“DAI KESSAN SĒRU”

By inputting a prompt as the above into the multimodal large language model 322, text as below is obtained as a translation result.

“Year-End Clearance Sale”

In S1802, the CPU 211 replaces the text included in the text object obtained in S1002 with the text output as a translation result from the multimodal large language model 322 with the text translation unit 313. Note that the text translation method is not limited to the method described above.

For example, the text translation unit 313 may hold a machine translation model that has been trained with a large number of pairs of to-be-translated text and translated text, and translate the text included in the text object using the machine translation model. Alternatively, pairs of to-be-translated text and translated text may be registered in the conversion database 323 in advance. Then, in a case where the text included in the text object is registered as to-be-translated text in the conversion database 323, the text translation unit 313 may replace the text with the translated text paired with the to-be-translated text.

In the example illustrated in FIGS. 16A and 16B, executing the character set changing process illustrated in FIG. 18 changes the text object 1611 illustrated in FIG. 16A to a text object 1621 illustrated in FIG. 16B. Specifically, the text included in the text object is translated from Japanese to English. Further, the to-be-emphasized word among the words included in the text is displayed in a larger font size than the font size of the words other than the to-be-emphasized word.

According to the present embodiment, in a case where the text included in a text object included in design data is translated to any language, a character set changing process is executed on the translation result. This improves the visual perceptibility of the to-be-emphasized elements in the text included in a text object also in a case of translating the text.

The present embodiment has been described based on an example in which, in a case where the text included in a text object included in design data is translated to any language, a character set changing process is executed on the translation result. Note that the service server 102 may obtain the to-be-emphasized elements in the design data before the text translation in advance, and specify the elements corresponding to the obtained to-be-emphasized elements among the elements in the translated text as the to-be-emphasized elements.

Specifically, as in S1401, the service server 102 obtains the emphasized words in the design data before the text translation. The service server 102 then specifies the elements corresponding to the emphasized words obtained before the translation among the elements in the translated text as the to-be-emphasized words. As described above, the service server 102 can specify elements corresponding to emphasized elements in design data before text translation among the elements of the text after the text translation as to-be-emphasized words.

### Fifth Embodiment

The first embodiment has been described based on an example in which to-be-emphasized elements are automatically specified from among the elements of the text included in a text object or objects included in design data and, based on the specified to-be-emphasized elements, the character set of these elements is changed on a word-by-word basis. In a fifth embodiment, a description will be given of an example in which the character set of the elements of the text included in a text object included currently edited design data is changed in a case where part of the text sticks out from the text region of the text object. Note that the basic configurations of the host PC and the service server in the present embodiment are similar to the configurations in the first embodiment, and detailed description thereof will therefore be omitted. The difference from the first embodiment will be described below.

### Processing Sequence

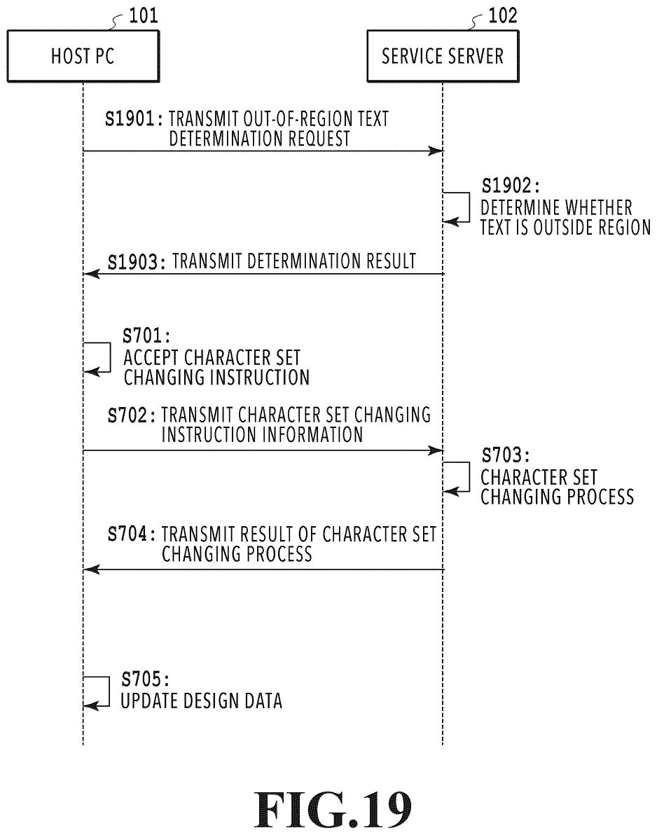

FIG. 19 is a sequence chart illustrating an example of processing to be executed by the host PC 101 and the service server 102. A sequence of processing by the system in the present embodiment will now be described with reference to FIG. 19. As compared to the processing sequence illustrated in FIG. 7, the processing sequence illustrated in FIG. 19 additionally includes the processes of S1901 to S1903.

In S1901, in a case where the text included in a text object included in currently edited design data is changed, the data transmission component 303 transmits an out-of-region text determination request to the service server 102. The out-of-region text determination request is a request to determine whether all of the elements of the text included in the text object included in the design data fit within the text region of the text object. In other words, the out-of-region text determination request is a request to determine whether or not some or all of the elements of the text are arranged (displayed) outside the text region.

In S1902, the service server 102 determines whether all of the elements of the text fit within the text region in response to the out-of-region text determination request received in S1901. Note that the process of S1902 is similar to the process of S1008.

In S1903, the data transmission unit 311 transmits the result of the determination for the out-of-region text determination request to the poster creation application 300.

### Flow of Processing by Host PC 101

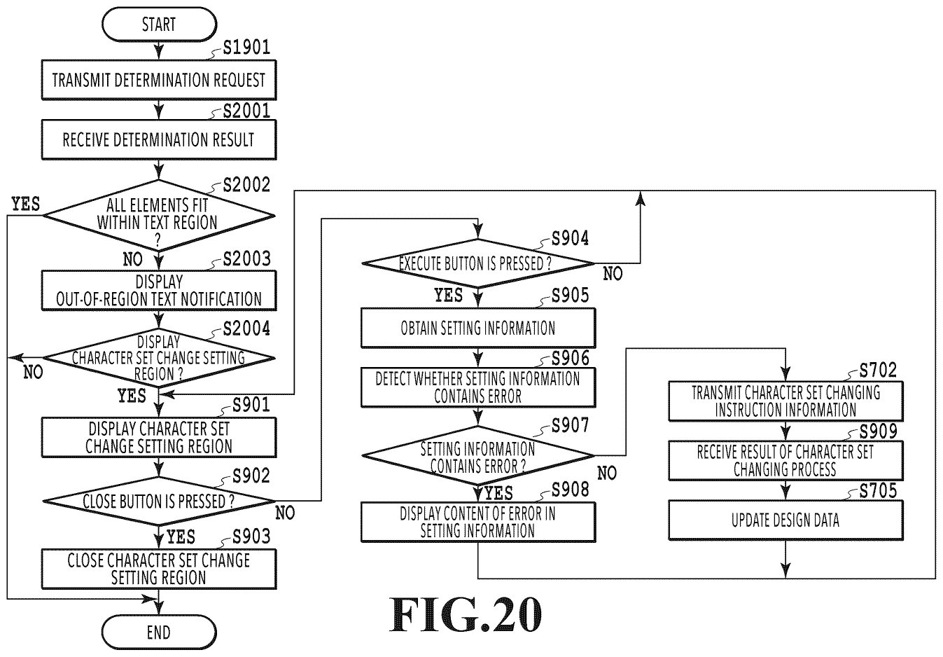

FIG. 20 is a flowchart illustrating an example of an acceptance process of accepting a character set changing instruction and a process of updating the display of the design data to be executed by the poster creation application 300 of the host PC 101 in the present embodiment. S901 to S909 and S2001 to S2004 illustrated in FIG. 20 are included in S701 illustrated in FIG. 19. Also, the processing illustrated in FIG. 20 is started in response to changing the text included in a text object included in the design data on the editing screen of the poster creation application 300.

The difference between the processing in the flowchart illustrated in FIG. 20 and that in the flowchart in the first embodiment illustrated in FIG. 9 will be described below. As compared to the flowchart in the first embodiment illustrated in FIG. 9, the flowchart illustrated in FIG. 20 additionally includes the processes of S2001 to S2004.

In S1901, the CPU 201 transmits an out-of-region text determination request to the service server 102 with the data transmission component 303.

In S2001, the CPU 201 receives a determination result for the out-of-region text determination request transmitted in S1901 from the service server 102 by the data transmission component 303 with the data reception component 304, and proceeds to S2002. The process in S2001 corresponds to the process illustrated in S1903.

In S2002, the CPU 201 determines whether all of the elements of the text fit within the text region with the display control component 301 based on the determination result received by the data reception component 304 in S2002. If determining in S2002 that all of the elements of the text fit within the text region (Yes) with the display control component 301, the CPU 201 terminates the flow. If determining in S2002 that not all of the elements of the text fit within the text region (No) with the display control component 301, the CPU 201 proceeds to S2003.

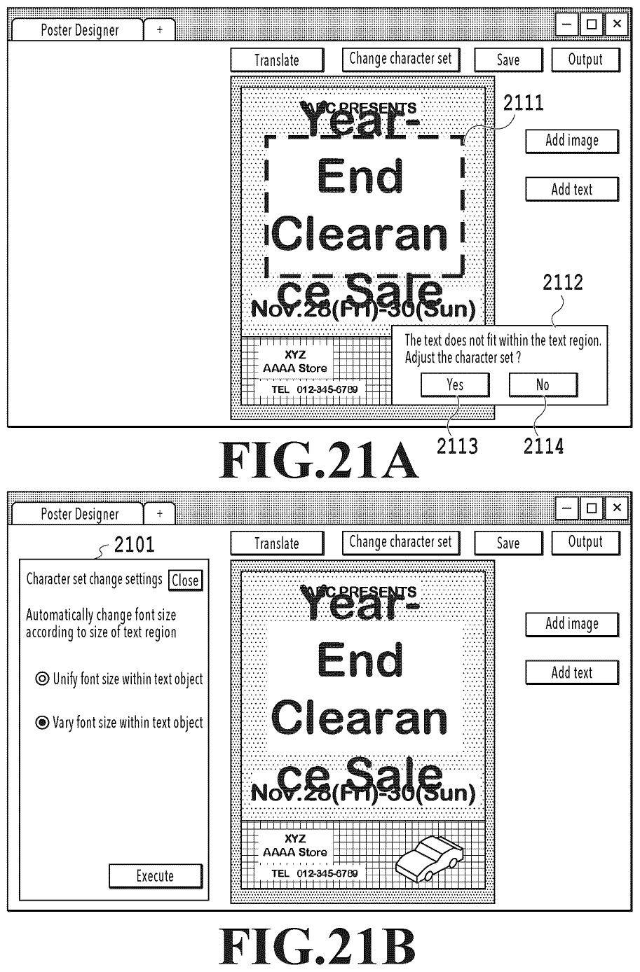

Specifically, the case where not all of the elements of the text fit within the text region is a case as illustrated in FIGS. 21A and 21B. FIGS. 21A and 21B are diagrams illustrating an example of the editing screen of the poster creation application 300 in the present embodiment. FIG. 21A is a diagram illustrating an example of the editing screen of the poster creation application 300 with the later-described out-of-region text notification displayed.

As illustrated in FIG. 21A, part of the text included in a text object is displayed to be outside an outer frame 2111 of the text region of this text object indicated by the dashed line. Specifically, among the elements of the text included in the text object, “Year-” and “ce Sale” are displayed to be outside the text region of the text object. In such a case, the display control component 301 determines that not all of the elements of the text fit within the text region.

In S2003, the CPU 201 issues an out-of-region text notification with the display control component 301. The out-of-region text notification is a notification to the user indicating that not all of the elements of the text included in the text object included the design data fit within the text region of the text object. For example, in S2003, the display control component 301 displays the out-of-region text notification in the form of a dialogue box on the editing screen of the poster creation application 300 as illustrated in FIG. 21A.

In an out-of-region text notification 2112 illustrated in FIG. 21A, a message indicating that not all of the elements of the text fit within the text region is displayed. Also, the out-of-region text notification 2112 is provided with a “Yes” button 2113 that accepts an instruction to display a character set change setting region 2101 and a “No” button 2114 that accepts an instruction not to display the character set change setting region 2101.

In S2004, the CPU 201 determines whether to display the character set change setting region 2101 with the display control component 301. Specifically, in S2004, the display control component 301 determines to display the character set change setting region 2101 (Yes) if detecting a press on the “Yes” button 2113 in the out-of-region text notification 2112 displayed in S2003, and proceeds to S901. Then, in S2004, the display control component 301 closes the out-of-region text notification 2112.

In S2004, the display control component 301 determines not to display the character set change setting region 2101 (No) if detecting a press on the “No” button 2114 in the out-of-region text notification 2112 displayed in S2003, and terminates the flow. Then, in S2004, the display control component 301 closes the out-of-region text notification 2112.

FIG. 21B is a diagram illustrating an example of the editing screen of the poster creation application 300 with the character set change setting region displayed. FIG. 21B illustrates the editing screen after the “Yes” button 2113 illustrated in FIG. 21A is pressed.

According to the present embodiment, it is possible to change the character set of the elements of text included in a text object included in currently edited design data in a case where not all of the elements of the text fit within the text region of the text object. This makes it possible to improve the visual perceptibility of the to-be-emphasized elements in the text also in a case where it is desirable to make the text fit within the text region.

### Sixth Embodiment

In a sixth embodiment, an example in which to-be-emphasized elements are specified based on the result of a morphological analysis will be described. A morphological analysis is, for example, an analysis for indicating the structure of text by classifying the elements of the text by the part of speech.

Note that the basic configurations of the host PC and the service server in the present embodiment are similar to the configurations in the first embodiment, and detailed description thereof will therefore be omitted. The difference from the first embodiment will be described below.

### Flow of Processing by Service Server 102

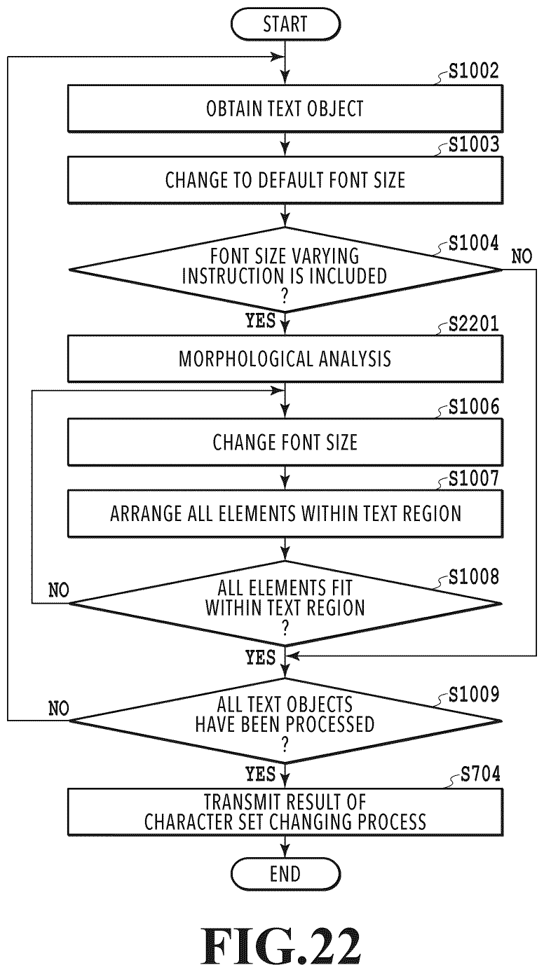

FIG. 22 is a flowchart illustrating an example of a character set changing process to be executed by the service server 102 in the present embodiment. The flow illustrated in FIG. 22 includes S704 illustrated in FIG. 7. S1002 to S1004, S1006 to S1009, and S2201 illustrated in FIG. 22 are included in S703 illustrated in FIG. 7. The processing illustrated in FIG. 22 is started in response to the data reception unit 312 of the service server 102 receiving character set changing instruction information from the poster creation application 300 of the host PC 101. The difference between the flowchart in the present embodiment (FIG. 22) and the flowchart in the first embodiment (FIG. 10) will be described below.

As compared to the flow in the flowchart illustrated in FIG. 10, the flowchart illustrated in FIG. 22 does not include S1001 and S1005 and additionally includes the process of S2201.

In S2201, the CPU 211 specifies the to-be-emphasized elements from among the elements of the text with the to-be-emphasized element specification unit 314 based on the result of a morphological analysis. The multimodal large language model 322 is used for the morphological analysis. The to-be-emphasized element specification unit 314 generates a prompt for causing the multimodal large language model 322 to execute the morphological analysis using the text included in the text object included in the design data. For example, the to-be-emphasized element specification unit 314 generates a prompt as below in a case where the text object 813 illustrated in FIG. 8A has been obtained.

“Perform morphological analysis on the following text.” “Nov.28(Fri)-30(Sun)”

By inputting a prompt as the above into the multimodal large language model 322, a morphological analysis result as below is obtained.
“Nouns: Nov., (Fri), (Sun)”
“Numerals: 28, 30”
“Symbols:-”

The to-be-emphasized element specification unit 314 determines the to-be-emphasized elements based on the result of the morphological analysis and morpheme-based to-be-emphasized element determination rules. The morpheme-based to-be-emphasized element determination rules are stored in the conversion database 323. Examples of the morpheme-based to-be-emphasized element determination rules include rules such as “determine nouns and numerals as to-be-emphasized elements” and “determine verbs, adjectives, adverbs, postpositional particles, auxiliary verbs, conjunctions, and symbols as not-to-be-emphasized elements.” The to-be-emphasized element specification unit 314 can specify the to-be-emphasized elements based on the above rules and the result of the morphological analysis. Note that the method of specifying the to-be-emphasized elements by a morphological analysis is not limited to the method described above. For example, for the morphological analysis in the present embodiment, a different morphological analysis algorithm may be applied to the text. Also, the to-be-emphasized elements determination rules are not limited to the rules described above as long as they are for determining to-be-emphasized elements based on the morpheme.

According to the present embodiment, to-be-emphasized elements can be specified from among the elements of the text included in text objects included in design data based on the result of a morphological analysis and morpheme-based to-be-emphasized element determination rules. Also, the to-be-emphasized elements can be automatically specified. This makes it possible to achieve a similar advantage to the advantage described in the first embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221919, filed Dec. 18, 2024, which is hereby incorporated by reference herein in its entirety.

What is claimed is:

1. A non-transitory computer-readable storage medium storing a program causing an information processing apparatus communicably connected with a terminal device to execute a method, the method comprising causing the information processing apparatus to function as:
an acceptance unit configured to accept a changing instruction to change a layout of design data including text from the terminal device;
a control unit configured to perform control which specifies an element to be emphasized from among elements included in the text based on the design data in a case where the changing instruction is accepted; and
a changing unit configured to change a character set of the element specified by the control unit.

2. The storage medium according to claim 1, wherein the character set is at least one of a size of the element, a color of the element, a font type of the element, bolding decoration for the element, underling decoration for the element, or italicizing decoration for the element.

3. The storage medium according to claim 1, wherein the control unit
further performs control which specifies a purpose of the design data based on the design data, and
specifies the element to be emphasized based on the specified purpose of the design data and the text.

4. The storage medium according to claim 3, wherein using a trained model capable of outputting purpose information indicating the purpose of the design data and to-be-emphasized element information indicating the element to be emphasized, the control unit further performs control which
obtains the purpose information from the trained model by inputting a prompt for causing the trained model to output the purpose information into the trained model, and
obtains the to-be-emphasized element information from the trained model by inputting the obtained purpose information, the text, and a prompt for outputting the to-be-emphasized element information into the trained model.

5. The storage medium according to claim 4, wherein the to-be-emphasized element information is information indicating an element to be emphasized at a high degree among the elements included in the text, and an element to be emphasized at a low degree among the elements included in the text.

6. The storage medium according to claim 1, wherein the control unit performs control which specifies the element to be emphasized based on types of the elements included in the text and a predetermined rule.

7. The storage medium according to claim 6, wherein
the types of the elements include a noun, a numerical, a verb, an adjective, an adverb, a postpositional particle, an auxiliary verb, and a conjunction, and
the predetermined rule indicates that nouns and numerals are to be specified as the elements to be emphasized and that verbs, adjectives, adverbs, postpositional particles, auxiliary verbs, and conjunctions are not to be specified as the elements to be emphasized.

8. The storage medium according to claim 1, wherein
the design data includes a plurality of pieces of the text,
the changing instruction includes target indicating information indicating a piece of text to be subjected to the control to be performed by the control unit among the plurality of pieces of the text, and
the control unit performs the control, which specifies the element to be emphasized, on the piece of text indicated by the target indicating information.

9. The storage medium according to claim 8, wherein the control unit does not perform the control, which specifies the element to be emphasized, on a piece of text other than the piece of text indicated by the target indicating information among the plurality of pieces of the text.

10. The storage medium according to claim 1, wherein
in a case where the acceptance unit accepts the changing instruction and then further accepts an instruction to specify the element to be emphasized in the design data representing a layout in which the character set of an element has been changed based on the changing instruction, the control unit specifies a second element to be emphasized which is different from a first element being the element specified in accordance with the changing instruction from among the elements included in the text, and
the changing unit changes the character set of the second element to emphasize the second element with respect to the elements other than the second element which include the first element among the elements included in the text.

11. The storage medium according to claim 1, wherein
the changing instruction includes a translation instruction as an instruction to translate the text from a first language to a second language, and
the control unit
further performs control which translates the elements included in the text from the first language to the second language in a case where the elements are represented in the first language, and
performs control which specifies the element to be emphasized from among the elements included in the text after the translation.

12. The storage medium according to claim 1, wherein in a case where the acceptance unit accepts a determination request to determine whether the text fits within a region provided to the text in the layout before accepting the changing instruction, the control unit further performs control which determines whether the text fits within the region provided to the text in the layout.

13. The storage medium according to claim 12, wherein in the case where the acceptance unit accepts the determination request before accepting the changing instruction, and the text does not fit within the region provided to the text in the layout, the changing unit changes the character set of the elements included in the text such that the text fits within the region provided to the text in the layout.

14. The storage medium according to claim 13, wherein the information processing apparatus is further caused to function as:
a display control unit configured to perform control which displays the layout of the design data with an application configured to generate the design data; and
an output unit configured to output the determination request in a case where the display control unit detects a change in the layout.

15. The storage medium according to claim 14, wherein the output unit further outputs the changing instruction in accordance with a user operation on a first screen being an editing screen of the application.

16. The storage medium according to claim 15, wherein the display control unit further performs control which displays a second screen capable of accepting whether to output the changing instruction with the output unit according to a determination result as a response to the determination request indicating that the text does not fit within the region in the layout.

17. The storage medium according to claim 16, wherein the output unit outputs the changing instruction in response to acceptance of an instruction to output the changing instruction on the second screen.

18. An information processing apparatus communicably connected with a terminal device, the information processing apparatus comprising:
wherein the at least one memory and the at least one processor further function as:
an acceptance unit configured to accept a changing instruction to change a layout of design data including text from the terminal device;
a control unit configured to perform control which specifies an element to be emphasized from among elements included in the text based on the design data in a case where the changing instruction is accepted; and
a changing unit configured to change a character set of the element specified by the control unit.

19. A method of controlling an information processing apparatus communicably connected with a terminal device, the method comprising:
accepting a changing instruction to change a layout of design data including text from the terminal device;
performing control which specifies an element to be emphasized from among elements included in the text based on the design data in a case where the changing instruction is accepted; and
changing a character set of the element specified by the control.
